(19) United States
(12) Patent Application Publication
(10) Pub. No.: US 2026/0301513 A1
(43) Pub. Date: Oct. 1, 2026

(54) HINGED SCREEN SUPPORT MECHANISM FOR GAMING MACHINES

(71) Applicant: Aristocrat Technologies, Inc., Las Vegas, NV (US)

(72) Inventors: Donald Rodd, Palm Beach Garden, FL (US); Timothy Barbour, Nolensville, TN (US)

(21) Appl. No.: 19/096,600

(22) Filed: Mar. 31, 2025

(51) Int. Cl. G07F 17/32

(52) U.S. Cl. CPC G07F 17/3216; G07F 17/3209; G07F 17/3211

(57) ABSTRACT

Mechanisms are disclosed that allow both display panels of a dual-display electronic gaming machine to be positioned such that their display surfaces face in the same, or generally the same, direction and form a relatively continuous aggregate display area. Such mechanisms also allow the secondary display panel to be pitched downward such that the display surface of the secondary display panel faces towards the display surface of the main display panel. In doing so, the secondary display panel may be rotated about a first axis positioned near where the main display panel and the secondary display panel met when forming the relatively continuous display area and flipped upside down, thereby decreasing the height of the electronic gaming machine by approximately the height of the secondary display panel.

### BACKGROUND

Electronic gaming machines (“EGMs”) or gaming devices provide a variety of wagering games such as slot games, video poker games, video blackjack games, roulette games, video bingo games, keno games and other types of games that are frequently offered at casinos and other locations. Play on EGMs typically involves a player establishing a credit balance by inputting money, or another form of monetary credit, and placing a monetary wager (from the credit balance) on one or more outcomes of an instance (or single play) of a primary or base game. In some cases, a player may qualify for a special mode of the base game, a secondary game, or a bonus round of the base game by attaining a certain winning combination or triggering event in, or related to, the base game, or after the player is randomly awarded the special mode, secondary game, or bonus round. In the special mode, secondary game, or bonus round, the player is given an opportunity to win extra game credits, game tokens or other forms of payout. In the case of “game credits” that are awarded during play, the game credits are typically added to a credit meter total on the EGM and can be provided to the player upon completion of a gaming session or when the player wants to “cash out.”

“Slot” type games are often displayed to the player in the form of various symbols arrayed in a row-by-column grid or matrix. Specific matching combinations of symbols along predetermined paths (or paylines) through the matrix indicate the outcome of the game. The display typically highlights winning combinations/outcomes for identification by the player. Matching combinations and their corresponding awards are usually shown in a “pay-table” which is available to the player for reference. Often, the player may vary his/her wager to include differing numbers of paylines and/or the amount bet on each line. By varying the wager, the player may sometimes alter the frequency or number of winning combinations, frequency or number of secondary games, and/or the amount awarded.

Typical games use a random number generator (RNG) to randomly determine the outcome of each game. The game is designed to return a certain percentage of the amount wagered back to the player over the course of many plays or instances of the game, which is generally referred to as return to player (RTP). The RTP and randomness of the RNG ensure the fairness of the games and are highly regulated. Upon initiation of play, the RNG randomly determines a game outcome and symbols are then selected which correspond to that outcome. Notably, some games may include an element of skill on the part of the player and are therefore not entirely random.

### SUMMARY

Discussed herein are designs for hinged screen support mechanisms for use in electronic gaming machines or other equipment having similar arrangements of screens. Modern electronic gaming machines have evolved considerably over the years, and some newer electronic gaming machines may include one or more large organic light-emitting diode (OLED), micro-light-emitting diode (micro LED), or other types of display panels that are used to display game graphics. In some instances, such display panels may be 42″ or longer along a diagonal axis. Moreover, some electronic gaming machines may feature multiple, e.g., two, such display panels, with one such display panel being positioned directly beneath the other such display panel so as to form, in effect, a single, larger display area.

Due to their height, such electronic gaming machines are imposing and attractive to players, are visible to spectators from further away, and also provide additional display real estate for showing game-related graphics, thereby providing greater flexibility to developers in terms of game mechanics and user interface design. However, the potential size of such electronic gaming machines also presents logistics challenges to the manufacturers and operators of such devices.

For example, electronic gaming machines are large devices that are usually packaged in crates or on shipping pallets and then loaded into shipping containers, tractor trailers, or other modes of transit. Once packaged for shipment, electronic gaming machines may need to be loaded into one or more vehicles for transport before arriving at their final destination—such vehicles often have limits on the maximum height of cargo that may be transported thereby. For example, a standard tractor trailer may have an interior height within the trailer of ~110″, which may not accommodate many dual-display electronic gaming machines. Moreover, once such an electronic gaming machine is delivered to its destination, it may be necessary to transport the electronic gaming machine using elevators and/or through doorways, both of which may be even more limited in height (standard interior doorways are on the order of between 80″ and 108″ tall).

As a result, it is often the case that dual or multi-display electronic gaming machines are shipped in a partially assembled state, with the upper display panel being removed from the cabinet of the electronic gaming machine. After such an electronic gaming machine is delivered to its final destination, the final assembly may be completed on-site in order to place the electronic gaming machine into an operable state. This may require multiple technicians and specialized equipment, as it may be necessary to physically lift the upper display panel into place and then secure it to a display mount in the electronic gaming machine. There is also a risk of personnel injury or equipment damage, as such display panels are often large, heavy, and awkward to hold and may thus be difficult to support during the mounting process.

Disclosed herein are various mechanisms that may be integrated into a dual-display electronic gaming machine (or other system having similar arrangements of display panels) in order to allow the electronic gaming machine to be placed into either a shipping configuration or a deployed configuration without requiring removal or installation of any display panels. It will be appreciated that such mechanisms may also be used to support, for example, toppers (e.g., wheel displays) or other devices that may, when an electronic gaming machine is in its deployed or installed state, be supported above a display panel of the electronic gaming machine, i.e., the mechanisms in question are not limited to only being used for dual-display electronic gaming machines (or other dual-display devices), but may also be used in single-display devices in which it is desired to position some other device, e.g., a spinning wheel mechanism, above a display panel of the device.

Such mechanisms may be configured to allow both display panels of a dual-display electronic gaming machine, e.g., a main display panel and a secondary display panel positioned above the main display panel, to be positioned such that their active display surfaces face in the same, or generally the same, direction and form a relatively continuous aggregate display area where the top edge of the main display panel is next to the bottom edge of the secondary display panel (the term “relatively continuous” is used since there will most likely be a small gap or seam between the display surfaces of the two display panels along the edges of the two display panels that are closest to one another). For example, the top edge of the main display panel and the bottom edge of the secondary display panel may be adjacent to one another, and the main display surface of the main display panel adjacent the top edge of the main display panel may be tangent to, and aligned with, the secondary display surface of the secondary display panel adjacent the bottom edge of the secondary display panel. For clarity, the term “display surface,” as used herein, refers to the surface of a display panel on which graphical content is displayed when the display panel is used to display such graphical content. Such mechanisms may also be configured, however, to allow the secondary display panel to be pitched downward such that the display surface of the main display panel (this display surface may be referred to herein as a “main display surface”) faces towards the secondary display panel. In some such implementations, the display surface of the secondary display panel (this display surface may be referred to herein as a “secondary display surface”) may face towards the main display panel. For such implementations, the secondary display panel may be rotated downward about a first axis positioned near where the main display panel and the secondary display panel met when forming the relatively continuous display area and flipped upside down in a stowed position, thereby decreasing the height of the electronic gaming machine by approximately the height of the secondary display panel (when in its deployed state). In other implementations, the secondary display panel may be mounted to one or more support arms that are rotated in such a fashion, but the secondary display panel may be rotatably connected with the end or ends of the one or more support arms and rotated in the opposite direction from the one or more support arms such that the secondary main display surface faces away from the main display surface when in the stowed position and the secondary display panel does not flip upside down.

Such a mechanism may be particularly effective when integrating other mechanisms that may assist with transitioning the secondary display between its stowed state and its deployed state, although the mechanism, at its broadest, may generally have the features or characteristics set forth above. These and other aspects of such apparatuses are discussed below in more detail and with respect to the Figures but include at least the following implementations.

In some implementations, an apparatus may be provided that includes a cabinet, a main display panel having a main display surface configured to display graphical output and a main display back side facing in an opposite direction from the main display surface, and a secondary display panel having a secondary display surface configured to display graphical output and a secondary display back side facing in an opposite direction from the main display surface. The apparatus may also include one or more support arms connected with the secondary display panel, the one or more support arms configured to rotate about a first axis relative to the cabinet and between a stowed position and a deployed position. The apparatus may further include a display mount with a base portion and a movable portion. The base portion may be connected with the cabinet, the main display panel may be connected with the movable portion, and the movable portion may be configured to move along a first path relative to the base portion. The main display surface of the main display panel may face towards the secondary display panel when the one or more support arms are in the stowed position, and the main display surface of the main display panel and the secondary display surface of the secondary display panel may both face in a common direction when the one or more support arms are in the deployed position.

In some implementations, the movable portion of the display mount may be movable between a first position and a second position relative to the base portion, a portion of the secondary display panel may occupy a first region when the one or more support arms are in the stowed position and the movable portion of the display mount is in the first position, and a portion of the main display panel may occupy the first region when the one or more support arms are in the deployed position and the movable portion of the display mount is in the second position.

In some implementations, no portion of the main display panel may occupy the first region when the one or more support arms are in the stowed position and the movable portion of the display mount is in the first position, and no portion of the secondary display panel may occupy the first region when the one or more support arms are in the deployed position and the movable portion of the display mount is in the second position.

In some implementations, the apparatus may further include a button deck connected with the cabinet. In such implementations, the main display panel and the secondary display panel may be positioned at a higher elevation than the button deck regardless of whether the one or more support arms are in the stowed position or the deployed position and regardless of whether the movable portion of the display mount is in the first position or the second position.

In some implementations, the apparatus may further include a driven sprocket, a drive sprocket, and a chain. The driven sprocket may be configured to rotate about the first axis and may be fixedly connected with the one or more support arms, the drive sprocket may be located within the cabinet and at a lower elevation than the drive sprocket, and the chain may be engaged with the driven sprocket and with the drive sprocket.

In some such implementations, the drive sprocket may be located in a base of the cabinet and at an elevation lower than any part of the main display panel.

In some implementations, the apparatus may further include a drive mechanism with a rotational input and a rotational output. The rotational output may be coupled with the drive sprocket and configured to cause the drive sprocket, and thus the one or more support arms, to rotate about the first axis responsive to rotation of the rotational output. In some such implementations, the rotational input may be accessible from outside of the cabinet.

In some implementations, when the one or more support arms are in the deployed position and the movable portion of the display mount is in the second position, a top edge of the main display panel and a bottom edge of the secondary display panel may be adjacent to one another, and the main display surface of the main display panel adjacent the top edge of the main display panel may be tangent to, and aligned with, the secondary display surface of the secondary display panel adjacent the bottom edge of the secondary display panel.

In some implementations, the main display panel may have a curved profile when viewed along the first axis.

In some implementations, the secondary display panel may have a curved profile when viewed along the first axis.

In some implementations, the secondary display panel may have a curved profile when viewed along the first axis.

In some implementations, the main display surface of the main display panel may face towards the secondary display surface of the secondary display panel when the one or more support arms are in the stowed position.

In some implementations, the secondary display panel may be fixedly mounted with respect to the one or more support arms.

In some implementations, the secondary display panel may be movably coupled with the one or more support arms and may be configured to move along a path relative to the one or more support arms.

In some implementations, the secondary display surface of the secondary display panel may face away from the main display surface of the main display panel when the one or more support arms are in the stowed position.

In some implementations, each support arm of the one or more support arms may have a first end and a second end opposite the first end, the first axis may pass through the first end or first ends of the one or more support arms, the secondary display panel may be rotatably connected with the second end or second ends of the one or more support arms, the secondary display panel may be configured to rotate about a second axis relative to the one or more support arms, and the second axis may pass through the second end or second ends of the one or more support arms.

In some implementations, the apparatus may further include a button deck connected with the cabinet. In such implementations, the main display panel and the secondary display panel may be positioned at a higher elevation than the button deck regardless of whether the one or more support arms are in the stowed position or the deployed position and regardless of whether the movable portion of the display mount is in the first position or the second position.

In some implementations, the apparatus may further include a button deck connected with the cabinet. In such implementations, the main display panel and the secondary display panel may be positioned at a higher elevation than the button deck when the one or more support arms are in the deployed position and the movable portion of the display mount is in the second position, the main display surface of the main display panel may face towards the secondary display back side of the secondary display panel when the one or more support arms are in the stowed position and the movable portion of the display mount is in the first position, and the button deck may be between the cabinet and the secondary display panel when the one or more support arms are in the stowed position and the movable portion of the display mount is in the first position.

In some implementations, the apparatus may further include one or more locking plates, each locking plate connected with one of the one or more support arms and with the cabinet or a structure that is fixed in space relative to the cabinet.

In some implementations, the apparatus may further include a motor configured to, when actuated, cause the one or more support arms to rotate about the first axis relative to the cabinet.

### BRIEF DESCRIPTION OF THE DRAWINGS

FIG. 1 is an exemplary diagram showing several EGMs networked with various gaming-related servers.

FIG. 2A is a block diagram showing various functional elements of an exemplary EGM.

FIG. 2B depicts a casino gaming environment according to one example.

FIG. 2C is a diagram that shows examples of components of a system for providing online gaming according to some aspects of the present disclosure.

FIG. 3 illustrates, in block diagram form, an implementation of a game processing architecture algorithm that implements a game processing pipeline for the play of a game in accordance with various implementations described herein.

FIG. 4 depicts side views of an example of a dual-display electronic gaming machine according to the present disclosure in both its stowed configuration and its fully deployed/in-use configuration.

FIG. 5 depicts a side view of the example dual-display electronic gaming machine of FIG. 4 in the stowed configuration.

FIGS. 6 through 8 depict side views the example dual-display electronic gaming machine of FIG. 4 in various states of transition from the stowed configuration of FIG. 4 to the deployed configuration of FIG. 4.

FIG. 9 depicts a side view of the example dual-display electronic gaming machine of FIG. 4 after the secondary display panel has been rotated into its fully upright position.

FIG. 10 depicts a side view of the example dual-display electronic gaming machine of FIG. 4 after the secondary display panel has been rotated into its fully upright position and the secondary display panel has been moved downward into its fully deployed position.

FIG. 11 depicts a side view of the example dual-display electronic gaming machine of FIG. 4 after the secondary display panel has been rotated into its fully upright position and the main display panel has been moved upward into its fully deployed position.

FIG. 12 is an isometric rear view of the dual-display electronic gaming machine of FIG. 4.

FIG. 13 is the same view of the dual-display electronic gaming machine of FIG. 12 but with the cabinet shown as transparent.

FIG. 14 is an exploded view of a hinge assembly and locking plate for the dual-display electronic gaming machine of FIG. 13.

FIG. 15 is a view of the locking plate installed in the hinge assembly of the dual-display electronic gaming machine of FIG. 13.

FIG. 16 is an exploded view of the dual-display electronic gaming machine of FIG. 4.

FIG. 17 is a detail view of a portion of FIG. 16.

FIG. 18 is a detail view of another portion of FIG. 16.

FIG. 19 is a side view of the example dual-display electronic gaming machine of FIG. 4 in the deployed configuration.

FIGS. 20 through 22 depict side views of the example dual-display electronic gaming machine of FIG. 4 in various states of transition from the deployed configuration to a maintenance configuration.

FIG. 23 is a side view of the example dual-display electronic gaming machine of FIG. 4 in the maintenance configuration.

FIGS. 24 and 25 depict an example dual-display electronic gaming machine with a variant of the concepts discussed herein.

FIGS. 26 and 27 depict another example dual-display electronic gaming machine with a variant of the concepts discussed herein.

FIGS. 28 and 29 depict another example dual-display electronic gaming machine with a variant of the concepts discussed herein.

FIG. 30 depicts a side view of an example dual-display electronic gaming machine with various drive systems depicted.

It will be understood that the examples shown in the Figures are not intended to be limiting, and that various other implementations will be apparent to those in the art.

### DETAILED DESCRIPTION

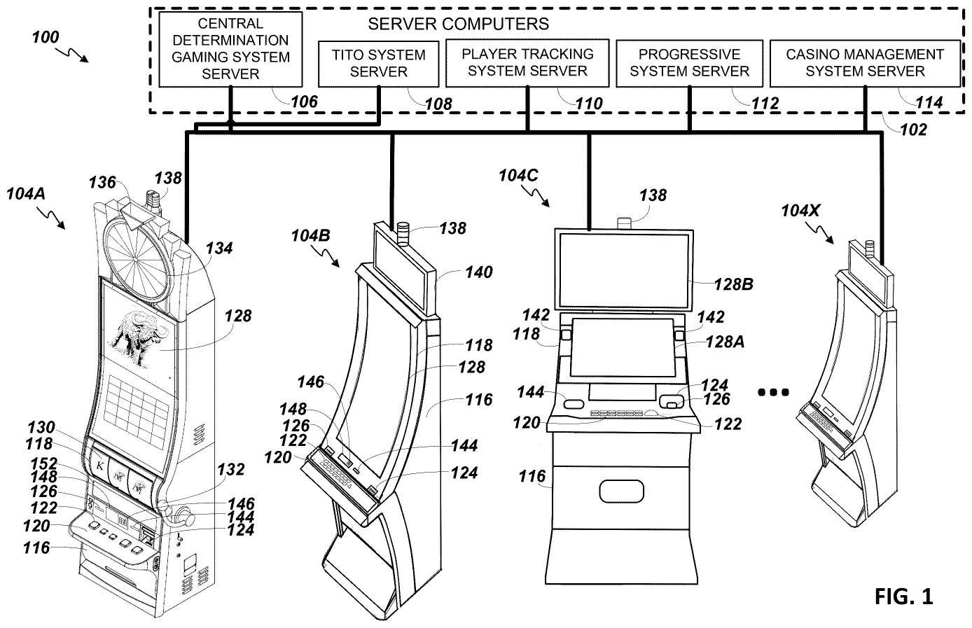

FIG. 1 illustrates several different models of EGMs which may be networked to various gaming-related servers. Shown is a system 100 in a gaming environment including one or more server computers 102 (e.g., slot servers of a casino) that are in communication, via a communications network, with one or more gaming devices 104A-104X (EGMs, slots, video poker, bingo machines, etc.) that can implement one or more aspects of the present disclosure. The gaming devices 104A-104X may alternatively be portable and/or remote gaming devices such as, but not limited to, a smart phone, a tablet, a laptop, or a game console. Gaming devices 104A-104X utilize specialized software and/or hardware to form non-generic, particular machines or apparatuses that comply with regulatory requirements regarding devices used for wagering or games of chance that provide monetary awards.

Communication between the gaming devices 104A-104X and the server computers 102, and among the gaming devices 104A-104X, may be direct or indirect using one or more communication protocols. As an example, gaming devices 104A-104X and the server computers 102 can communicate over one or more communication networks, such as over the Internet through a website maintained by a computer on a remote server or over an online data network including commercial online service providers, Internet service providers, private networks (e.g., local area networks and enterprise networks), and the like (e.g., wide area networks). The communication networks could allow gaming devices 104A-104X to communicate with one another and/or the server computers 102 using a variety of communication-based technologies, such as radio frequency (RF) (e.g., wireless fidelity (WiFi®) and Bluetooth®), cable TV, satellite links and the like.

In some implementations, server computers 102 may not be necessary and/or preferred. For example, in one or more implementations, a stand-alone gaming device such as gaming device 104A, gaming device 104B or any of the other gaming devices 104C-104X can implement one or more aspects of the present disclosure. However, it is typical to find multiple EGMs connected to networks implemented with one or more of the different server computers 102 described herein.

The server computers 102 may include a central determination gaming system server 106, a ticket-in-ticket-out (TITO) system server 108, a player tracking system server 110, a progressive system server 112, and/or a casino management system server 114. Gaming devices 104A-104X may include features to enable operation of any or all servers for use by the player and/or operator (e.g., the casino, resort, gaming establishment, tavern, pub, etc.). For example, game outcomes may be generated on a central determination gaming system server 106 and then transmitted over the network to any of a group of remote terminals or remote gaming devices 104A-104X that utilize the game outcomes and display the results to the players.

Gaming device 104A is often of a cabinet construction which may be aligned in rows or banks of similar devices for placement and operation on a casino floor. The gaming device 104A often includes a main door which provides access to the interior of the cabinet. Gaming device 104A typically includes a button area or button deck 120 accessible by a player that is configured with input switches or buttons 122, an access channel for a bill validator 124, and/or an access channel for a ticket-out printer 126.

In FIG. 1, gaming device 104A is shown as a Relm XL™ model gaming device manufactured by Aristocrat® Technologies, Inc. As shown, gaming device 104A is a reel machine having a gaming display area 118 comprising a number (typically 3 or 5) of mechanical reels 130 with various symbols displayed on them. The mechanical reels 130 are independently spun and stopped to show a set of symbols within the gaming display area 118 which may be used to determine an outcome to the game.

In many configurations, the gaming device 104A may have a main display 128 (e.g., video display monitor) mounted to, or above, the gaming display area 118. The main display 128 can be a high-resolution liquid crystal display (LCD), plasma, light emitting diode (LED), or organic light emitting diode (OLED) panel which may be flat or curved as shown, a cathode ray tube, or other conventional electronically controlled video monitor.

In some implementations, the bill validator 124 may also function as a “ticket-in” reader that allows the player to use a casino issued credit ticket to load credits onto the gaming device 104A (e.g., in a cashless ticket (“TITO”) system). In such cashless implementations, the gaming device 104A may also include a “ticket-out” printer 126 for outputting a credit ticket when a “cash out” button is pressed. Cashless TITO systems are used to generate and track unique bar-codes or other indicators printed on tickets to allow players to avoid the use of bills and coins by loading credits using a ticket reader and cashing out credits using a ticket-out printer 126 on the gaming device 104A. The gaming device 104A can have hardware meters for purposes including ensuring regulatory compliance and monitoring the player credit balance. In addition, there can be additional meters that record the total amount of money wagered on the gaming device, total amount of money deposited, total amount of money withdrawn, total amount of winnings on gaming device 104A.

In some implementations, a player tracking card reader 144, a transceiver for wireless communication with a mobile device (e.g., a player's smartphone), a keypad 146, and/or an illuminated display 148 for reading, receiving, entering, and/or displaying player tracking information is provided in gaming device 104A. In such implementations, a game controller within the gaming device 104A can communicate with the player tracking system server 110 to send and receive player tracking information.

Gaming device 104A may also include a bonus topper wheel 134. When bonus play is triggered (e.g., by a player achieving a particular outcome or set of outcomes in the primary game), bonus topper wheel 134 is operative to spin and stop with indicator arrow 136 indicating the outcome of the bonus game. Bonus topper wheel 134 is typically used to play a bonus game, but it could also be incorporated into play of the base or primary game.

A candle 138 may be mounted on the top of gaming device 104A and may be activated by a player (e.g., using a switch or one of buttons 122) to indicate to operations staff that gaming device 104A has experienced a malfunction or the player requires service. The candle 138 is also often used to indicate a jackpot has been won and to alert staff that a hand payout of an award may be needed.

There may also be one or more information panels 152 which may be a back-lit, silkscreened glass panel with lettering to indicate general game information including, for example, a game denomination (e.g., $0.25 or $1), pay lines, pay tables, and/or various game related graphics. In some implementations, the information panel(s) 152 may be implemented as an additional video display.

Gaming devices 104A have traditionally also included a handle 132 typically mounted to the side of main cabinet 116 which may be used to initiate game play.

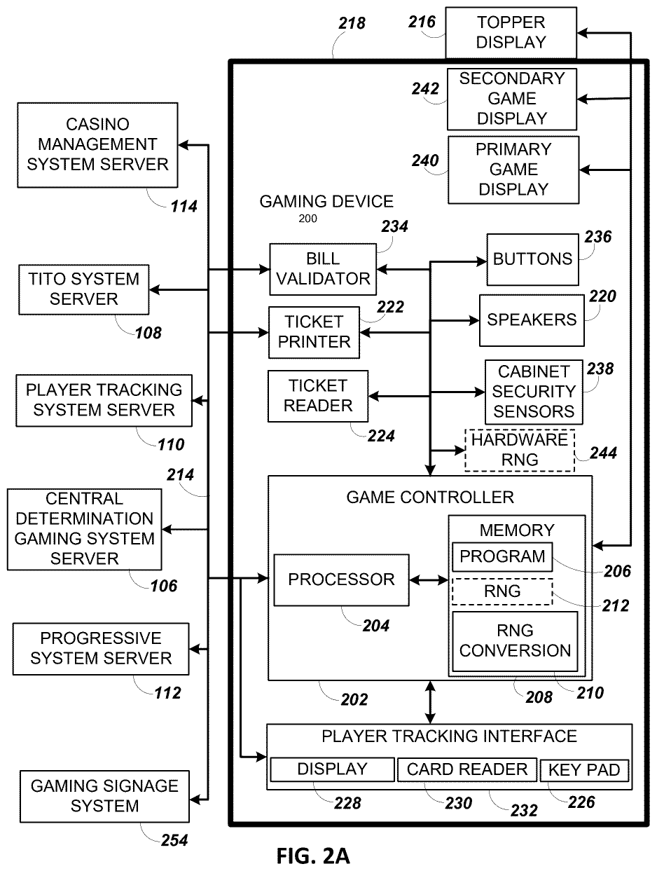

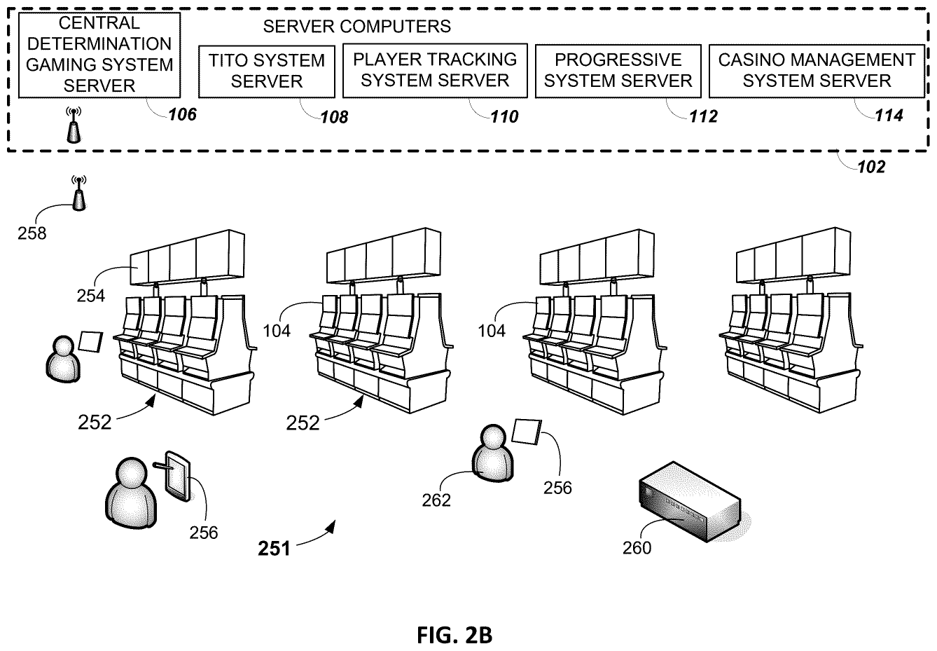

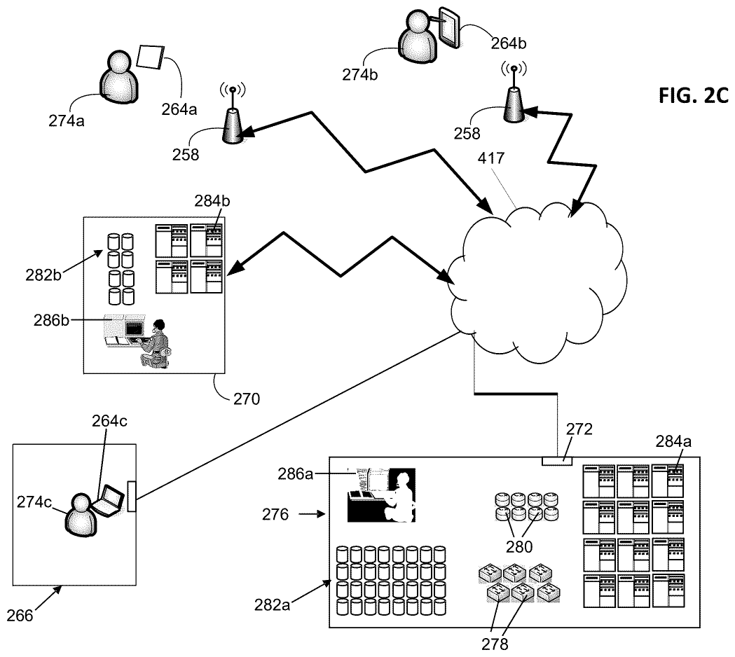

Many or all the above-described components can be controlled by circuitry (e.g., a game controller) housed inside the main cabinet 116 of the gaming device 104A, the details of which are shown in FIG. 2A.

An alternative example gaming device 104B illustrated in FIG. 1 is the Arc^{TM} model gaming device manufactured by Aristocrat® Technologies, Inc. Note that where possible, reference numerals identifying similar features of the gaming device 104A implementation are also identified in the gaming device 104B implementation using the same reference numbers. Gaming device 104B does not include physical reels and instead shows game play functions on main display 128. An optional topper screen 140 may be used as a secondary game display for bonus play, to show game features or attraction activities while a game is not in play, or any other information or media desired by the game designer or operator. In some implementations, the optional topper screen 140 may also or alternatively be used to display progressive jackpot prizes available to a player during play of gaming device 104B.

Example gaming device 104B includes a main cabinet 116 including a main door which opens to provide access to the interior of the gaming device 104B. The main or service door is typically used by service personnel to refill the ticket-out printer 126 and collect bills and tickets inserted into the bill validator 124. The main or service door may also be accessed to reset the machine, verify and/or upgrade the software, and for general maintenance operations.

Another example gaming device 104C shown is the Helix^{TM} model gaming device manufactured by Aristocrat® Technologies, Inc. Gaming device 104C includes a main display 128A that is in a landscape orientation. Although not illustrated by the front view provided, the main display 128A may have a curvature radius from top to bottom, or alternatively from side to side. In some implementations, main display 128A is a flat panel display. Main display 128A is typically used for primary game play while secondary display 128B is typically used for bonus game play, to show game features or attraction activities while the game is not in play or any other information or media desired by the game designer or operator. In some implementations, example gaming device 104C may also include speakers 142 to output various audio such as game sound, background music, etc.

Many different types of games, including mechanical slot games, video slot games, video poker, video black jack, video pachinko, keno, bingo, and lottery, may be provided with or implemented within the depicted gaming devices 104A-104C and other similar gaming devices. Each gaming device may also be operable to provide many different games. Games may be differentiated according to themes, sounds, graphics, type of game (e.g., slot game vs. card game vs. game with aspects of skill), denomination, number of paylines, maximum jackpot, progressive or non-progressive, bonus games, and may be deployed for operation in Class 2 or Class 3, etc.

FIG. 2A is a block diagram depicting exemplary internal electronic components of a gaming device 200 connected to various external systems. All or parts of the gaming device 200 shown could be used to implement any one of the example gaming devices 104A-X depicted in FIG. 1. As shown in FIG. 2A, gaming device 200 includes a topper display 216 or another form of a top box (e.g., a topper wheel, a topper screen, etc.) that sits above cabinet 218. Cabinet 218 or topper display 216 may also house a number of other components which may be used to add features to a game being played on gaming device 200, including speakers 220, a ticket printer 222 which prints bar-coded tickets or other media or mechanisms for storing or indicating a player's credit value, a ticket reader 224 which reads bar-coded tickets or other media or mechanisms for storing or indicating a player's credit value, and a player tracking interface 232. Player tracking interface 232 may include a keypad 226 for entering information, a player tracking display 228 for displaying information (e.g., an illuminated or video display), a card reader 230 for receiving data and/or communicating information to and from media or a device such as a smart phone enabling player tracking. FIG. 2 also depicts utilizing a ticket printer 222 to print tickets for a TITO system server 108. Gaming device 200 may further include a bill validator 234, player-input buttons 236 for player input, cabinet security sensors 238 to detect unauthorized opening of the cabinet 218, a primary game display 240, and a secondary game display 242, each coupled to and operable under the control of game controller 202.

The games available for play on the gaming device 200 are controlled by a game controller 202 that includes one or more processors 204. Processor 204 represents a general-purpose processor, a specialized processor intended to perform certain functional tasks, or a combination thereof. As an example, processor 204 can be a central processing unit (CPU) that has one or more multi-core processing units and memory mediums (e.g., cache memory) that function as buffers and/or temporary storage for data. Alternatively, processor 204 can be a specialized processor, such as an application specific integrated circuit (ASIC), graphics processing unit (GPU), field-programmable gate array (FPGA), digital signal processor (DSP), or another type of hardware accelerator. In another example, processor 204 is a system on chip (SoC) that combines and integrates one or more general-purpose processors and/or one or more specialized processors. Although FIG. 2A illustrates that game controller 202 includes a single processor 204, game controller 202 is not limited to this representation and instead can include multiple processors 204 (e.g., two or more processors).

FIG. 2A illustrates that processor 204 is operatively coupled to memory 208. Memory 208 is defined herein as including volatile and nonvolatile memory and other types of non-transitory data storage components. Volatile memory is memory that do not retain data values upon loss of power. Nonvolatile memory is memory that do retain data upon a loss of power. Examples of memory 208 include random access memory (RAM), read-only memory (ROM), hard disk drives, solid-state drives, universal serial bus (USB) flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, examples of RAM include static random access memory (SRAM), dynamic random access memory (DRAM), magnetic random access memory (MRAM), and other such devices. Examples of ROM include a programmable read-only memory (PROM), an erasable programmable read-only memory (EPROM), an electrically erasable programmable read-only memory (EEPROM), or other like memory device. Even though FIG. 2A illustrates that game controller 202 includes a single memory 208, game controller 202 could include multiple memories 208 for storing program instructions and/or data.

Memory 208 can store one or more game programs 206 that provide program instructions and/or data for carrying out various implementations (e.g., game mechanics) described herein. Stated another way, game program 206 represents an executable program stored in any portion or component of memory 208. In one or more implementations, game program 206 is embodied in the form of source code that includes human-readable statements written in a programming language or machine code that contains numerical instructions recognizable by a suitable execution system, such as a processor 204 in a game controller or other system. Examples of executable programs include: (1) a compiled program that can be translated into machine code in a format that can be loaded into a random access portion of memory 208 and run by processor 204; (2) source code that may be expressed in proper format such as object code that is capable of being loaded into a random access portion of memory 208 and executed by processor 204; and (3) source code that may be interpreted by another executable program to generate instructions in a random access portion of memory 208 to be executed by processor 204.

Alternatively, game programs 206 can be set up to generate one or more game instances based on instructions and/or data that gaming device 200 exchanges with one or more remote gaming devices, such as a central determination gaming system server 106 (not shown in FIG. 2A but shown in FIG. 1). For purpose of this disclosure, the term “game instance” refers to a play or a round of a game that gaming device 200 presents (e.g., via a user interface (UI)) to a player. The game instance is communicated to gaming device 200 via the network 214 and then displayed on gaming device 200. For example, gaming device 200 may execute game program 206 as video streaming software that allows the game to be displayed on gaming device 200. When a game is stored on gaming device 200, it may be loaded from memory 208 (e.g., from a read only memory (ROM)) or from the central determination gaming system server 106 to memory 208.

Gaming devices, such as gaming device 200, are highly regulated to ensure fairness and, in many cases, gaming device 200 is operable to award monetary awards (e.g., typically dispensed in the form of a redeemable voucher). Therefore, to satisfy security and regulatory requirements in a gaming environment, hardware and software architectures are implemented in gaming devices 200 that differ significantly from those of general-purpose computers. Adapting general purpose computers to function as gaming devices 200 is not simple or straightforward because of: (1) the regulatory requirements for gaming devices 200, (2) the harsh environment in which gaming devices 200 operate, (3) security requirements, (4) fault tolerance requirements, and (5) the requirement for additional special purpose componentry enabling functionality of an EGM. These differences require substantial engineering effort with respect to game design implementation, game mechanics, hardware components, and software.

One regulatory requirement for games running on gaming device 200 generally involves complying with a certain level of randomness. Typically, gaming jurisdictions mandate that gaming devices 200 satisfy a minimum level of randomness without specifying how a gaming device 200 should achieve this level of randomness. To comply, FIG. 2A illustrates that gaming device 200 could include an RNG 212 that utilizes hardware and/or software to generate RNG outcomes that lack any pattern. The RNG operations are often specialized and non-generic in order to comply with regulatory and gaming requirements. For example, in a slot game, game program 206 can initiate multiple RNG calls to RNG 212 to generate RNG outcomes, where each RNG call and RNG outcome corresponds to an outcome for a reel. In another example, gaming device 200 can be a Class II gaming device where RNG 212 generates RNG outcomes for creating Bingo cards. In one or more implementations, RNG 212 could be one of a set of RNGs operating on gaming device 200. More generally, an output of the RNG 212 can be the basis on which game outcomes are determined by the game controller 202. Game developers could vary the degree of true randomness for each RNG (e.g., pseudorandom) and utilize specific RNGs depending on game requirements. The output of the RNG 212 can include a random number or pseudorandom number (either is generally referred to as a “random number”).

In FIG. 2A, RNG 212 and hardware RNG 244 are shown in dashed lines to illustrate that RNG 212, hardware RNG 244, or both can be included in gaming device 200. In one implementation, instead of including RNG 212, gaming device 200 could include a hardware RNG 244 that generates RNG outcomes. Analogous to RNG 212, hardware RNG 244 performs specialized and non-generic operations in order to comply with regulatory and gaming requirements. For example, because of regulation requirements, hardware RNG 244 could be a random number generator that securely produces random numbers for cryptography use. The gaming device 200 then uses the secure random numbers to generate game outcomes for one or more game features. In another implementation, the gaming device 200 could include both hardware RNG 244 and RNG 212. RNG 212 may utilize the RNG outcomes from hardware RNG 244 as one of many sources of entropy for generating secure random numbers for the game features.

Another regulatory requirement for running games on gaming device 200 includes ensuring a certain level of RTP. Similar to the randomness requirement discussed above, numerous gaming jurisdictions also mandate that gaming device 200 provides a minimum level of RTP (e.g., RTP of at least 75%). A game can use one or more lookup tables (also called weighted tables) as part of a technical solution that satisfies regulatory requirements for randomness and RTP. In particular, a lookup table can integrate game features (e.g., trigger events for special modes or bonus games; newly introduced game elements such as extra reels, new symbols, or new cards; stop positions for dynamic game elements such as spinning reels, spinning wheels, or shifting reels; or card selections from a deck) with random numbers generated by one or more RNGs, so as to achieve a given level of volatility for a target level of RTP. (In general, volatility refers to the frequency or probability of an event such as a special mode, payout, etc. For example, for a target level of RTP, a higher-volatility game may have a lower payout most of the time with an occasional bonus having a very high payout, while a lower-volatility game has a steadier payout with more frequent bonuses of smaller amounts.) Configuring a lookup table can involve engineering decisions with respect to how RNG outcomes are mapped to game outcomes for a given game feature, while still satisfying regulatory requirements for RTP. Configuring a lookup table can also involve engineering decisions about whether different game features are combined in a given entry of the lookup table or split between different entries (for the respective game features), while still satisfying regulatory requirements for RTP and allowing for varying levels of game volatility.

FIG. 2A illustrates that gaming device 200 includes an RNG conversion engine 210 that translates the RNG outcome from RNG 212 to a game outcome presented to a player. To meet a designated RTP, a game developer can set up the RNG conversion engine 210 to utilize one or more lookup tables to translate the RNG outcome to a symbol element, stop position on a reel strip layout, and/or randomly chosen aspect of a game feature. As an example, the lookup tables can regulate a prize payout amount for each RNG outcome and how often the gaming device 200 pays out the prize payout amounts. The RNG conversion engine 210 could utilize one lookup table to map the RNG outcome to a game outcome displayed to a player and a second lookup table as a pay table for determining the prize payout amount for each game outcome. The mapping between the RNG outcome to the game outcome controls the frequency in hitting certain prize payout amounts.

FIG. 2A also depicts that gaming device 200 is connected over network 214 to player tracking system server 110. Player tracking system server 110 may be, for example, an OASIS® system manufactured by Aristocrat® Technologies, Inc. Player tracking system server 110 is used to track play (e.g., amount wagered, games played, time of play and/or other quantitative or qualitative measures) for individual players so that an operator may reward players in a loyalty program. The player may use the player tracking interface 232 to access his/her account information, activate free play, and/or request various information. Player tracking or loyalty programs seek to reward players for their play and help build brand loyalty to the gaming establishment. The rewards typically correspond to the player's level of patronage (e.g., to the player's playing frequency and/or total amount of game plays at a given casino). Player tracking rewards may be complimentary and/or discounted meals, lodging, entertainment and/or additional play. Player tracking information may be combined with other information that is now readily obtainable by a casino management system.

When a player wishes to play the gaming device 200, he/she can insert cash or a ticket voucher through a coin acceptor (not shown) or bill validator 234 to establish a credit balance on the gaming device. The credit balance is used by the player to place wagers on instances of the game and to receive credit awards based on the outcome of winning instances. The credit balance is decreased by the amount of each wager and increased upon a win. The player can add additional credits to the balance at any time. The player may also optionally insert a loyalty club card into the card reader 230. During the game, the player views with one or more UIs, the game outcome on one or more of the primary game display 240 and secondary game display 242. Other game and prize information may also be displayed.

For each game instance, a player may make selections, which may affect play of the game. For example, the player may vary the total amount wagered by selecting the amount bet per line and the number of lines played. In many games, the player is asked to initiate or select options during course of game play (such as spinning a wheel to begin a bonus round or select various items during a feature game). The player may make these selections using the player-input buttons 236, the primary game display 240 which may be a touch screen, or using some other device which enables a player to input information into the gaming device 200.

During certain game events, the gaming device 200 may display visual and auditory effects that can be perceived by the player. These effects add to the excitement of a game, which makes a player more likely to enjoy the playing experience. Auditory effects include various sounds that are projected by the speakers 220. Visual effects include flashing lights, strobing lights or other patterns displayed from lights on the gaming device 200 or from lights behind the information panel 152 (FIG. 1).

When the player is done, he/she cashes out the credit balance (typically by pressing a cash out button to receive a ticket from the ticket printer 222). The ticket may be “cashed-in” for money or inserted into another machine to establish a credit balance for play.

Additionally, or alternatively, gaming devices 104A-104X and 200 can include or be coupled to one or more wireless transmitters, receivers, and/or transceivers (not shown in FIGS. 1 and 2A) that communicate (e.g., Bluetooth® or other near-field communication technology) with one or more mobile devices to perform a variety of wireless operations in a casino environment. Examples of wireless operations in a casino environment include detecting the presence of mobile devices, performing credit, points, comps, or other marketing or hard currency transfers, establishing wagering sessions, and/or providing a personalized casino-based experience using a mobile application. In one implementation, to perform these wireless operations, a wireless transmitter or transceiver initiates a secure wireless connection between a gaming device 104A-104X and 200 and a mobile device. After establishing a secure wireless connection between the gaming device 104A-104X and 200 and the mobile device, the wireless transmitter or transceiver does not send and/or receive application data to and/or from the mobile device. Rather, the mobile device communicates with gaming devices 104A-104X and 200 using another wireless connection (e.g., WiFi® or cellular network). In another implementation, a wireless transceiver establishes a secure connection to directly communicate with the mobile device. The mobile device and gaming device 104A-104X and 200 sends and receives data utilizing the wireless transceiver instead of utilizing an external network. For example, the mobile device would perform digital wallet transactions by directly communicating with the wireless transceiver. In one or more implementations, a wireless transmitter could broadcast data received by one or more mobile devices without establishing a pairing connection with the mobile devices.

Although FIGS. 1 and 2A illustrate specific implementations of a gaming device (e.g., gaming devices 104A-104X and 200), the disclosure is not limited to those implementations shown in FIGS. 1 and 2. For example, not all gaming devices suitable for implementing implementations of the present disclosure necessarily include top wheels, top boxes, information panels, cashless ticket systems, and/or player tracking systems. Further, some suitable gaming devices have only a single game display that includes only a mechanical set of reels and/or a video display, while others are designed for bar counters or tabletops and have displays that face upwards. Gaming devices 104A-104X and 200 may also include other processors that are not separately shown. Using FIG. 2A as an example, gaming device 200 could include display controllers (not shown in FIG. 2A) configured to receive video input signals or instructions to display images on game displays 240 and 242. Alternatively, such display controllers may be integrated into the game controller 202. The use and discussion of FIGS. 1 and 2 are examples to facilitate ease of description and explanation.

FIG. 2B depicts a casino gaming environment according to one example. In this example, the casino 251 includes banks 252 of EGMs 104. In this example, each bank 252 of EGMs 104 includes a corresponding gaming signage system 254 (also shown in FIG. 2A). According to this implementation, the casino 251 also includes mobile gaming devices 256, which are also configured to present wagering games in this example. The mobile gaming devices 256 may, for example, include tablet devices, cellular phones, smart phones and/or other handheld devices. In this example, the mobile gaming devices 256 are configured for communication with one or more other devices in the casino 251, including but not limited to one or more of the server computers 102, via wireless access points 258.

According to some examples, the mobile gaming devices 256 may be configured for stand-alone determination of game outcomes. However, in some alternative implementations the mobile gaming devices 256 may be configured to receive game outcomes from another device, such as the central determination gaming system server 106, one of the EGMs 104, etc.

Some mobile gaming devices 256 may be configured to accept monetary credits from a credit or debit card, via a wireless interface (e.g., via a wireless payment app), via tickets, via a patron casino account, etc. However, some mobile gaming devices 256 may not be configured to accept monetary credits via a credit or debit card. Some mobile gaming devices 256 may include a ticket reader and/or a ticket printer whereas some mobile gaming devices 256 may not, depending on the particular implementation.

In some implementations, the casino 251 may include one or more kiosks 260 that are configured to facilitate monetary transactions involving the mobile gaming devices 256, which may include cash out and/or cash in transactions. The kiosks 260 may be configured for wired and/or wireless communication with the mobile gaming devices 256. The kiosks 260 may be configured to accept monetary credits from casino patrons 262 and/or to dispense monetary credits to casino patrons 262 via cash, a credit or debit card, via a wireless interface (e.g., via a wireless payment app), via tickets, etc. According to some examples, the kiosks 260 may be configured to accept monetary credits from a casino patron and to provide a corresponding amount of monetary credits to a mobile gaming device 256 for wagering purposes, e.g., via a wireless link such as a near-field communications link. In some such examples, when a casino patron 262 is ready to cash out, the casino patron 262 may select a cash out option provided by a mobile gaming device 256, which may include a real button or a virtual button (e.g., a button provided via a graphical user interface) in some instances. In some such examples, the mobile gaming device 256 may send a “cash out” signal to a kiosk 260 via a wireless link in response to receiving a “cash out” indication from a casino patron. The kiosk 260 may provide monetary credits to the casino patron 262 corresponding to the “cash out” signal, which may be in the form of cash, a credit ticket, a credit transmitted to a financial account corresponding to the casino patron, etc.

In some implementations, a cash-in process and/or a cash-out process may be facilitated by the TITO system server 108. For example, the TITO system server 108 may control, or at least authorize, ticket-in and ticket-out transactions that involve a mobile gaming device 256 and/or a kiosk 260.

Some mobile gaming devices 256 may be configured for receiving and/or transmitting player loyalty information. For example, some mobile gaming devices 256 may be configured for wireless communication with the player tracking system server 110. Some mobile gaming devices 256 may be configured for receiving and/or transmitting player loyalty information via wireless communication with a patron's player loyalty card, a patron's smartphone, etc.

According to some implementations, a mobile gaming device 256 may be configured to provide safeguards that prevent the mobile gaming device 256 from being used by an unauthorized person. For example, some mobile gaming devices 256 may include one or more biometric sensors and may be configured to receive input via the biometric sensor(s) to verify the identity of an authorized patron. Some mobile gaming devices 256 may be configured to function only within a predetermined or configurable area, such as a casino gaming area.

FIG. 2C is a diagram that shows examples of components of a system for providing online gaming according to some aspects of the present disclosure. As with other figures presented in this disclosure, the numbers, types and arrangements of gaming devices shown in FIG. 2C are merely shown by way of example. In this example, various gaming devices, including but not limited to end user devices (EUDs) 264a, 264b and 264c are capable of communication via one or more networks 417. The networks 417 may, for example, include one or more cellular telephone networks, the Internet, etc. In this example, the EUDs 264a and 264b are mobile devices: according to this example the EUD 264a is a tablet device and the EUD 264b is a smart phone. In this implementation, the EUD 264c is a laptop computer that is located within a residence 266 at the time depicted in FIG. 2C. Accordingly, in this example the hardware of EUDs is not specifically configured for online gaming, although each EUD is configured with software for online gaming. For example, each EUD may be configured with a web browser. Other implementations may include other types of EUD, some of which may be specifically configured for online gaming.

In this example, a gaming data center 276 includes various devices that are configured to provide online wagering games via the networks 417. The gaming data center 276 may, for example, be a remote gaming server (RGS) or similar system in some implementations. The gaming data center 276 is capable of communication with the networks 417 via the gateway 272. In this example, switches 278 and routers 280 are configured to provide network connectivity for devices of the gaming data center 276, including storage devices 282a, servers 284a and one or more workstations 570a. The servers 284a may, for example, be configured to provide access to a library of games for online game play. In some examples, code for executing at least some of the games may initially be stored on one or more of the storage devices 282a. The code may be subsequently loaded onto a server 284a after selection by a player via an EUD and communication of that selection from the EUD via the networks 417. The server 284a onto which code for the selected game has been loaded may provide the game according to selections made by a player and indicated via the player's EUD. In other examples, code for executing at least some of the games may initially be stored on one or more of the servers 284a. Although only one gaming data center 276 is shown in FIG. 2C, some implementations may include multiple gaming data centers 276.

In this example, a financial institution data center 270 is also configured for communication via the networks 417. Here, the financial institution data center 270 includes servers 284b, storage devices 282b, and one or more workstations 286b. According to this example, the financial institution data center 270 is configured to maintain financial accounts, such as checking accounts, savings accounts, loan accounts, etc. In some implementations one or more of the authorized users 274a-274c may maintain at least one financial account with the financial institution that is serviced via the financial institution data center 270.

According to some implementations, the gaming data center 276 may be configured to provide online wagering games in which money may be won or lost. According to some such implementations, one or more of the servers 284a may be configured to monitor player credit balances, which may be expressed in game credits, in currency units, or in any other appropriate manner. In some implementations, the server(s) 284a may be configured to obtain financial credits from and/or provide financial credits to one or more financial institutions, according to a player's “cash in” selections, wagering game results and a player's “cash out” instructions. According to some such implementations, the server(s) 284a may be configured to electronically credit or debit the account of a player that is maintained by a financial institution, e.g., an account that is maintained via the financial institution data center 270. The server(s) 284a may, in some examples, be configured to maintain an audit record of such transactions.

In some alternative implementations, the gaming data center 276 may be configured to provide online wagering games for which credits may not be exchanged for cash or the equivalent. In some such examples, players may purchase game credits for online game play, but may not “cash out” for monetary credit after a gaming session. Moreover, although the financial institution data center 270 and the gaming data center 276 include their own servers and storage devices in this example, in some examples the financial institution data center 270 and/or the gaming data center 276 may use offsite “cloud-based” servers and/or storage devices. In some alternative examples, the financial institution data center 270 and/or the gaming data center 276 may rely entirely on cloud-based servers.

One or more types of devices in the gaming data center 276 (or elsewhere) may be capable of executing middleware, e.g., for data management and/or device communication. Authentication information, player tracking information, etc., including but not limited to information obtained by EUDs 264 and/or other information regarding authorized users of EUDs 264 (including but not limited to the authorized users 274a-274c), may be stored on storage devices 282 and/or servers 284. Other game-related information and/or software, such as information and/or software relating to leaderboards, players currently playing a game, game themes, game-related promotions, game competitions, etc., also may be stored on storage devices 282 and/or servers 284. In some implementations, some such game-related software may be available as “apps” and may be downloadable (e.g., from the gaming data center 276) by authorized users.

In some examples, authorized users and/or entities (such as representatives of gaming regulatory authorities) may obtain gaming-related information via the gaming data center 276. One or more other devices (such EUDs 264 or devices of the gaming data center 276) may act as intermediaries for such data feeds. Such devices may, for example, be capable of applying data filtering algorithms, executing data summary and/or analysis software, etc. In some implementations, data filtering, summary and/or analysis software may be available as “apps” and downloadable by authorized users.

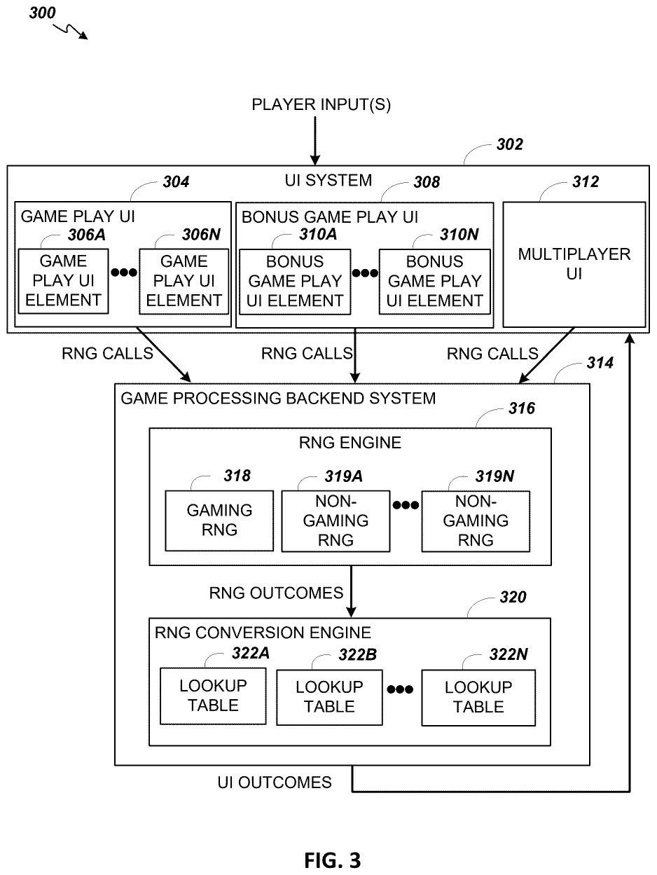

FIG. 3 illustrates, in block diagram form, an implementation of a game processing architecture 300 that implements a game processing pipeline for the play of a game in accordance with various implementations described herein. As shown in FIG. 3, the gaming processing pipeline starts with having a UI system 302 receive one or more player inputs for the game instance. Based on the player input(s), the UI system 302 generates and sends one or more RNG calls to a game processing backend system 314. Game processing backend system 314 then processes the RNG calls with RNG engine 316 to generate one or more RNG outcomes. The RNG outcomes are then sent to the RNG conversion engine 320 to generate one or more game outcomes for the UI system 302 to display to a player. The game processing architecture 300 can implement the game processing pipeline using a gaming device, such as gaming devices 104A-104X and 200 shown in FIGS. 1 and 2, respectively. Alternatively, portions of the gaming processing architecture 300 can implement the game processing pipeline using a gaming device and one or more remote gaming devices, such as central determination gaming system server 106 shown in FIG. 1.

The UI system 302 includes one or more UIs that a player can interact with. The UI system 302 could include one or more game play UIs 304, one or more bonus game play UIs 308, and one or more multiplayer UIs 312, where each UI type includes one or more mechanical UIs and/or graphical UIs (GUIs). In other words, game play UI 304, bonus game play UI 308, and the multiplayer UI 312 may utilize a variety of UI elements, such as mechanical UI elements (e.g., physical “spin” button or mechanical reels) and/or GUI elements (e.g., virtual reels shown on a video display or a virtual button deck) to receive player inputs and/or present game play to a player. Using FIG. 3 as an example, the different UI elements are shown as game play UI elements 306A-306N and bonus game play UI elements 310A-310N.

The game play UI 304 represents a UI that a player typically interfaces with for a base game. During a game instance of a base game, the game play UI elements 306A-306N (e.g., GUI elements depicting one or more virtual reels) are shown and/or made available to a user. In a subsequent game instance, the UI system 302 could transition out of the base game to one or more bonus games. The bonus game play UI 308 represents a UI that utilizes bonus game play UI elements 310A-310N for a player to interact with and/or view during a bonus game. In one or more implementations, at least some of the game play UI element 306A-306N are similar to the bonus game play UI elements 310A-310N. In other implementations, the game play UI element 306A-306N can differ from the bonus game play UI elements 310A-310N.

FIG. 3 also illustrates that UI system 302 could include a multiplayer UI 312 purposed for game play that differs or is separate from the typical base game. For example, multiplayer UI 312 could be set up to receive player inputs and/or presents game play information relating to a tournament mode. When a gaming device transitions from a primary game mode that presents the base game to a tournament mode, a single gaming device is linked and synchronized to other gaming devices to generate a tournament outcome. For example, multiple RNG engines 316 corresponding to each gaming device could be collectively linked to determine a tournament outcome. To enhance a player's gaming experience, tournament mode can modify and synchronize sound, music, reel spin speed, and/or other operations of the gaming devices according to the tournament game play. After tournament game play ends, operators can switch back the gaming device from tournament mode to a primary game mode to present the base game. Although FIG. 3 does not explicitly depict that multiplayer UI 312 includes UI elements, multiplayer UI 312 could also include one or more multiplayer UI elements.

Based on the player inputs, the UI system 302 could generate RNG calls to a game processing backend system 314. As an example, the UI system 302 could use one or more application programming interfaces (APIs) to generate the RNG calls. To process the RNG calls, the RNG engine 316 could utilize gaming RNG 318 and/or non-gaming RNGs 319A-319N. Gaming RNG 318 could corresponds to RNG 212 or hardware RNG 244 shown in FIG. 2A. As previously discussed with reference to FIG. 2A, gaming RNG 318 often performs specialized and non-generic operations that comply with regulatory and/or game requirements. For example, because of regulation requirements, gaming RNG 318 could correspond to RNG 212 by being a cryptographic RNG or pseudorandom number generator (PRNG) (e.g., Fortuna PRNG) that securely produces random numbers for one or more game features. To securely generate random numbers, gaming RNG 318 could collect random data from various sources of entropy, such as from an operating system (OS) and/or a hardware RNG (e.g., hardware RNG 244 shown in FIG. 2A). Alternatively, non-gaming RNGs 319A-319N may not be cryptographically secure and/or be computationally less expensive. Non-gaming RNGs 319A-319N can, thus, be used to generate outcomes for non-gaming purposes. As an example, non-gaming RNGs 319A-319N can generate random numbers for generating random messages that appear on the gaming device.

The RNG conversion engine 320 processes each RNG outcome from RNG engine 316 and converts the RNG outcome to a UI outcome that is feedback to the UI system 302. With reference to FIG. 2A, RNG conversion engine 320 corresponds to RNG conversion engine 210 used for game play. As previously described, RNG conversion engine 320 translates the RNG outcome from the RNG 212 to a game outcome presented to a player. RNG conversion engine 320 utilizes one or more lookup tables 322A-322N to regulate a prize payout amount for each RNG outcome and how often the gaming device pays out the derived prize payout amounts. In one example, the RNG conversion engine 320 could utilize one lookup table to map the RNG outcome to a game outcome displayed to a player and a second lookup table as a pay table for determining the prize payout amount for each game outcome. In this example, the mapping between the RNG outcome and the game outcome controls the frequency in hitting certain prize payout amounts. Different lookup tables could be utilized depending on the different game modes, for example, a base game versus a bonus game.

After generating the UI outcome, the game processing backend system 314 sends the UI outcome to the UI system 302. Examples of UI outcomes are symbols to display on a video reel or reel stops for a mechanical reel. In one example, if the UI outcome is for a base game, the UI system 302 updates one or more game play UI elements 306A-306N, such as symbols, for the game play UI 304. In another example, if the UI outcome is for a bonus game, the UI system could update one or more bonus game play UI elements 310A-310N (e.g., symbols) for the bonus game play UI 308. In response to updating the appropriate UI, the player may subsequently provide additional player inputs to initiate a subsequent game instance that progresses through the game processing pipeline.

As discussed earlier, electronic gaming machines that have dual displays may be difficult to ship or transport from one location to another in an assembled state due to their height. Some such electronic gaming machines may, for example, be more than 8 ft, 9 ft, 10 ft, 11 ft, or 12 ft tall, making it difficult or impossible to ship them in a standard shipping container or standard enclosed trailer and often making it difficult or impossible to move such electronic gaming machines from some portions of a facility, e.g., a casino, to other portions of the facility, e.g., in cases where such movement involves needing to move the electronic gaming machines through a doorway or via an elevator. Electronic gaming machines are typically designed to remain in an upright configuration and are not designed to be shipped or moved in a prone configuration, so tipping the electronic gaming machines over on their sides or front or back is usually not an option.

Discussed below are various implementations of mechanisms, as discussed earlier, that may be configured to allow both display panels of a dual-display electronic gaming machine, e.g., a main display panel and a secondary display panel positioned above the main display panel, to be positioned such that their display surfaces face in the same, or generally the same, direction and form a relatively continuous aggregate display area. Such mechanisms may also, in some cases, be configured to allow the secondary display panel to be pitched downward such that the secondary display surface of the secondary display panel faces towards the main display surface of the main display panel. In doing so, the secondary display panel may be rotated about a first axis positioned near where the main display panel and the secondary display panel met when forming the relatively continuous display area and flipped upside down, thereby decreasing the height of the electronic gaming machine by approximately the height of the secondary display panel (when in its deployed state).

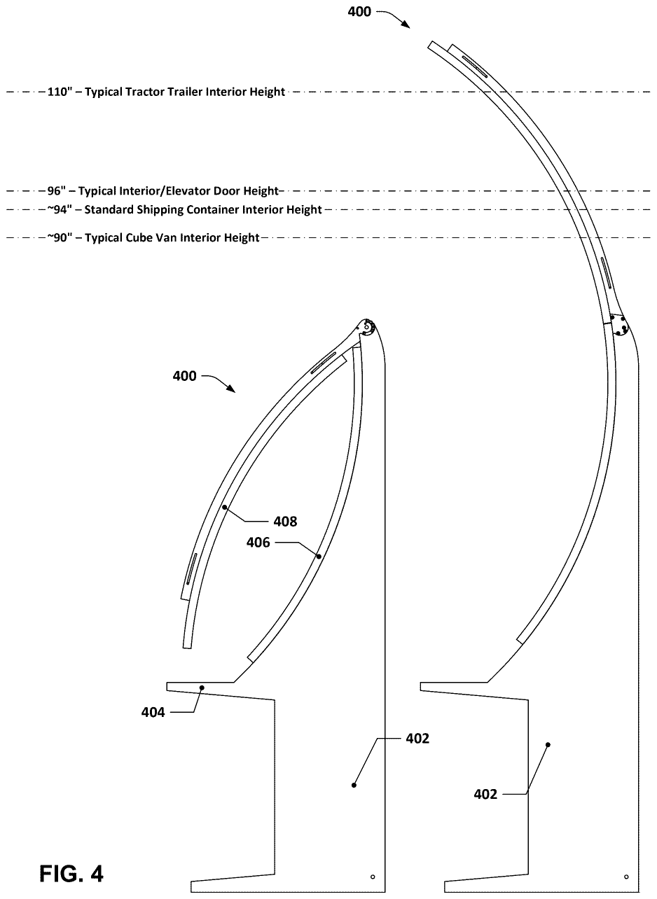

FIG. 4 depicts side views of an example of a dual-display electronic gaming machine according to the present disclosure in both its stowed configuration (at left) and its fully deployed/in-use configuration (at right). As can be seen, the electronic gaming machine 400 includes a main display panel 406 and a secondary display panel 408 that are arranged in a vertically stacked configuration, e.g., such that a main display surface 410 of the main display panel 406 and a secondary display surface 414 of the secondary display panel 408 form a generally continuous display surface, in effect acting like one large display panel. A gap 420 may be present between the main display surface 410 and the secondary display surface 414, although such a gap may be quite small, e.g., on the order of less than 1% of the height of the main display device.

The electronic gaming machine 400 may also include a cabinet 402 that may enclose various systems and structures of the electronic gaming machine 400, e.g., power supplies, electronics components, bill acceptors, display panel support systems, speakers, etc. The cabinet 402 in this example has a rear wall 403 and a base 401. The base 401 may be designed to rest on the floor of a casino or other establishment.

The electronic gaming machine 400 in this example also includes a button deck 404. The button deck 404 may provide various user-selectable controls, e.g., buttons, touch-screen interfaces, etc., that may allow a user to interact with, and play, a game offered by the electronic gaming machine 400. In this example, the button deck 404 is a “virtual button deck” that does not include physical buttons and instead provides for user input via a touch-screen interface. The button deck 404 may, in other implementations, include one or more physical/electromechanical buttons.

FIG. 4 also depicts, for comparison, the elevations of a typical interior door or elevator door (96″), a typical interior height of a standard ISO shipping container (~94″), a typical “cube van” (~90″), and the interior ceiling height of a typical tractor trailer (110″). As can be seen, the example electronic gaming machine 400 is, when in its fully deployed/in-use state, taller than all four of these elevations.

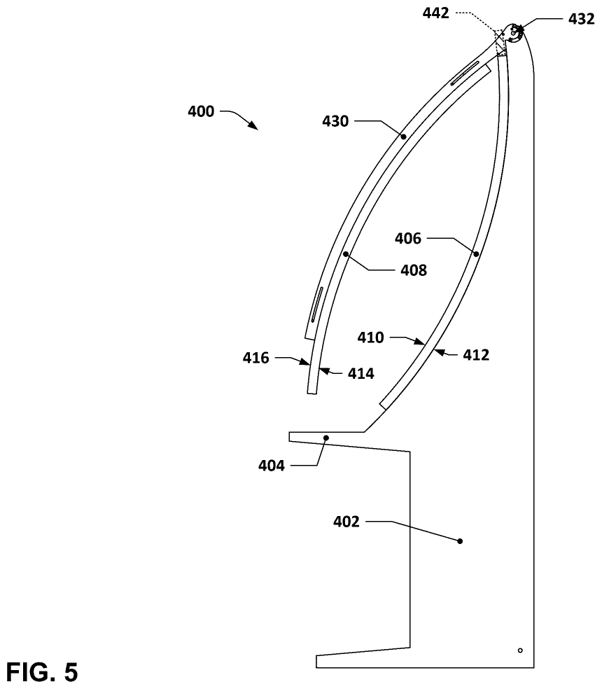

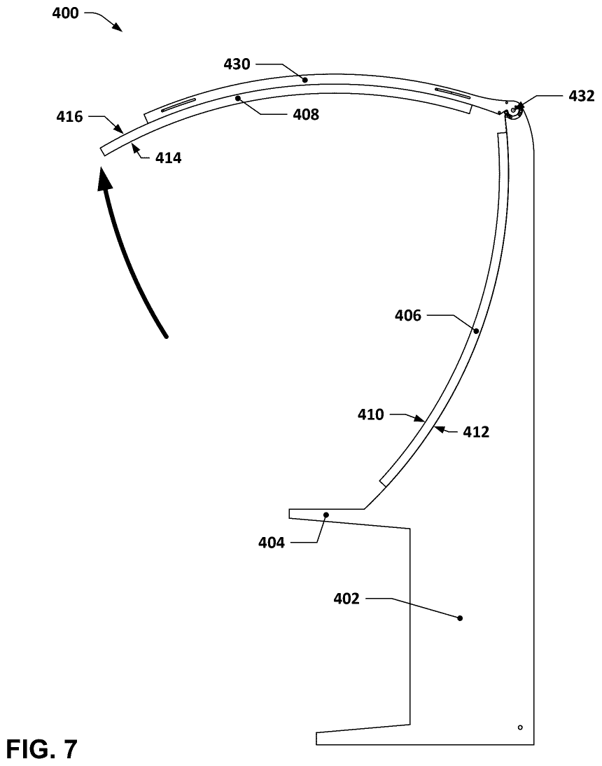

The electronic gaming machine 400, however, is able to be placed into a stowed or shipping configuration, as shown at left, due to its incorporation of various features that permit the secondary display panel 408 to be folded downward such that the secondary display surface 414 faces towards the main display surface 410 of the main display panel 406. After arriving at its destination and being moved into position, the secondary display panel 408 may be moved from its stowed configuration and into the deployed configuration. Such movements are depicted in FIGS. 5 through 11.

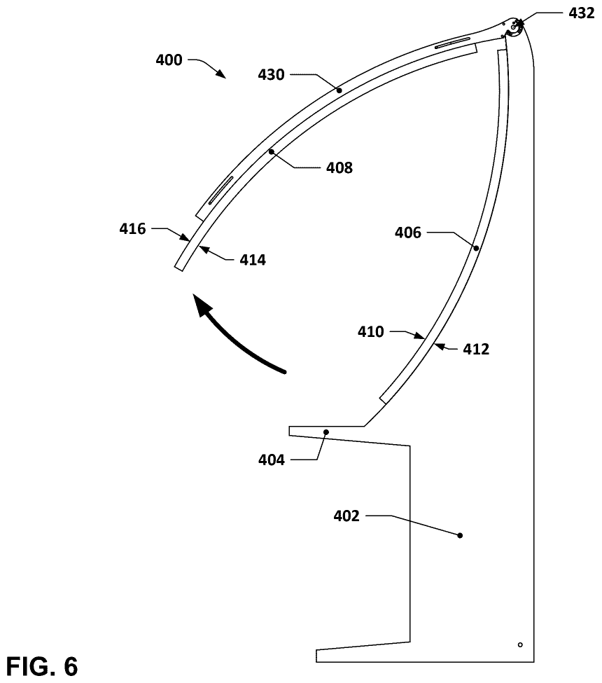

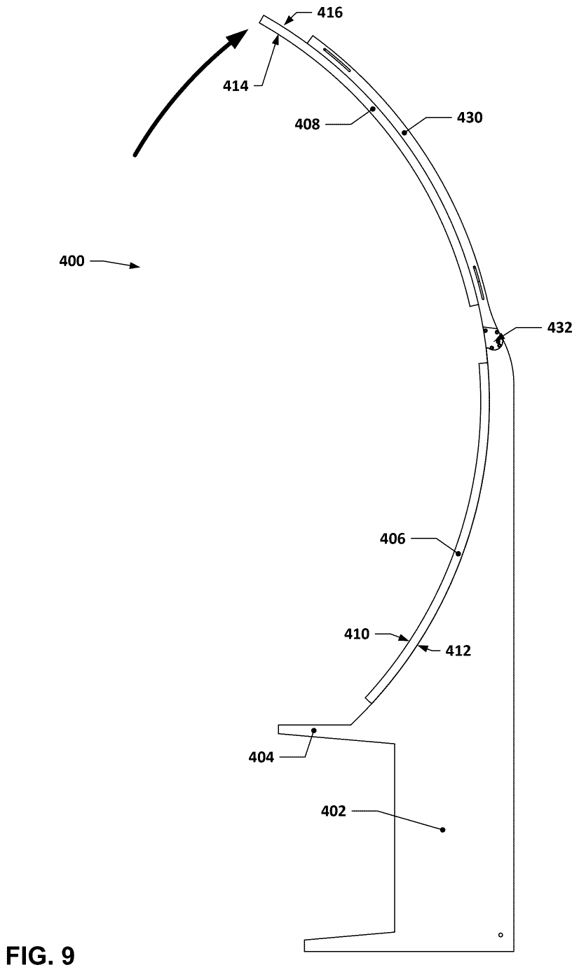

As can be seen from FIGS. 6 through 9, the secondary display panel 408 may be mounted to one or more support arms 430 that may be rotatably connected with the gaming machine cabinet 402 by way of one or more hinge assemblies. The one or more hinge assemblies may be configured to allow the one or more support arms 430 to be rotated about a first axis 432, as shown in FIGS. 6 through 8, and into its fully upright position, as shown in FIG. 9.

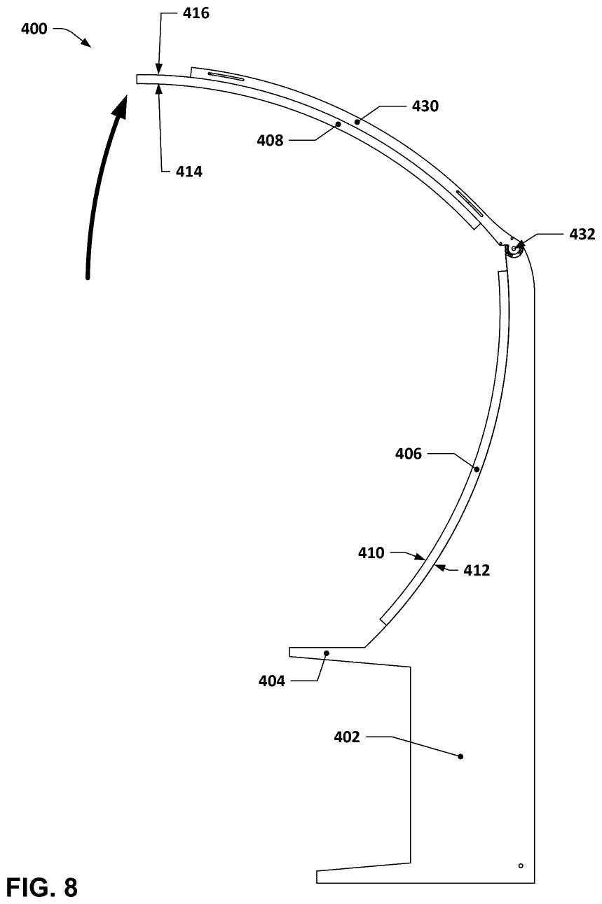

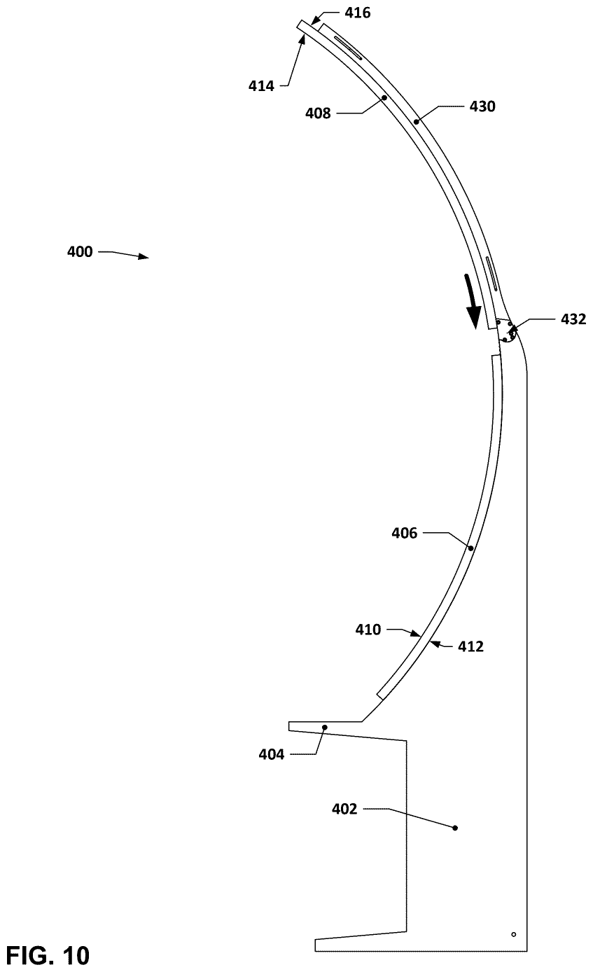

The secondary display panel 408 may be mounted to the one or more support arms 430 by way of one or more secondary display brackets 420 that may be movably engaged with the one or more support arms 430 such that the one or more secondary display brackets 420, as well as the secondary display panel 408 mounted thereto, may be capable of limited movement along the length of the one or more support arms 430. As can be seen in FIG. 10, after the one or more support arms 430 are rotated into their fully upright positions, the secondary display panel 408 may be moved downward along the one or more support arms 430 until the secondary display panel 408 reaches its fully deployed configuration, as shown in FIG. 10. Such movement may also start to occur before the one or more support arms 430 reach their fully upright positions. For example, the secondary display brackets 420 and secondary display panel 408 may be caused to start moving towards the first axis 432 by the force of gravity after the one or more support arms 430 reach a sufficiently high position, e.g., such as is shown in FIG. 8.

As shown in FIG. 10, the electronic gaming machine 400 is almost fully in the deployed configuration. In order to complete the reconfiguration of the electronic gaming machine 400, the main display panel 406 may be caused to move upward towards the secondary display panel 408, thereby reducing or eliminating the gap between the bottom edge of the secondary display panel 408 and the top edge of the main display panel 406.

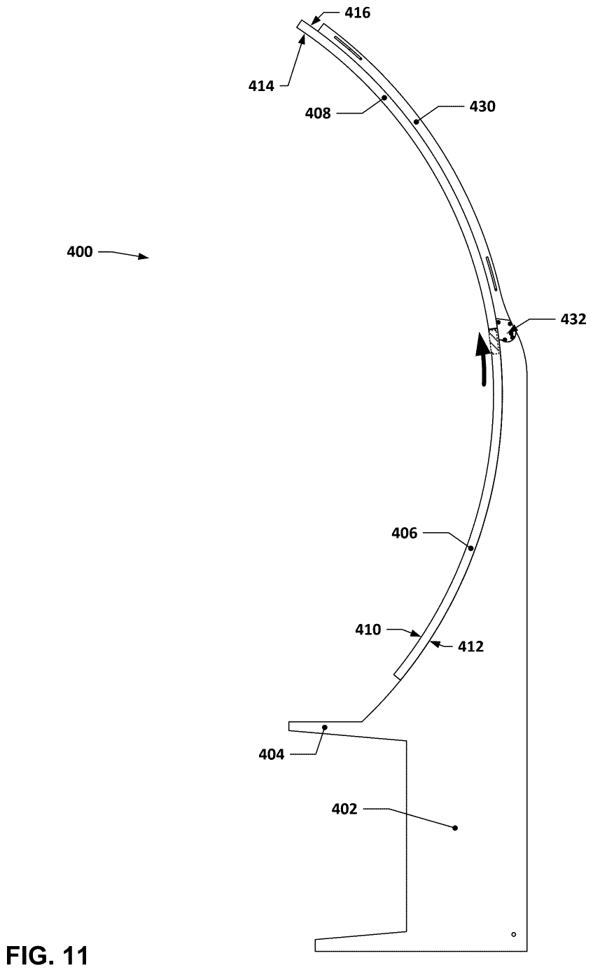

It will be noted that there is a first region 442 that is shown in FIGS. 5 and 11. The first region 442 is a region that is occupied by a portion of the secondary display panel 408 when the electronic gaming machine 400 is in the stowed configuration and is not occupied by any portion of the main display panel 406 and which is occupied by a portion of the main display panel 406 when the electronic gaming machine 400 is in the deployed configuration and is not occupied by any portion of the secondary display panel 408. By having the main display panel 406 be able to move out of the first region 442 when transitioning into the stowed configuration, the electronic gaming machine 400 is able to avoid a collision between the secondary display panel 408 and the main display panel 406 when transitioning to the stowed configuration. When the one or more support arms 430 are rotated up into the fully upright position, as shown in FIG. 9, this acts to remove the secondary display panel 408 from the first region 442, thereby freeing the first region 442 up to later be occupied by the main display panel 406.

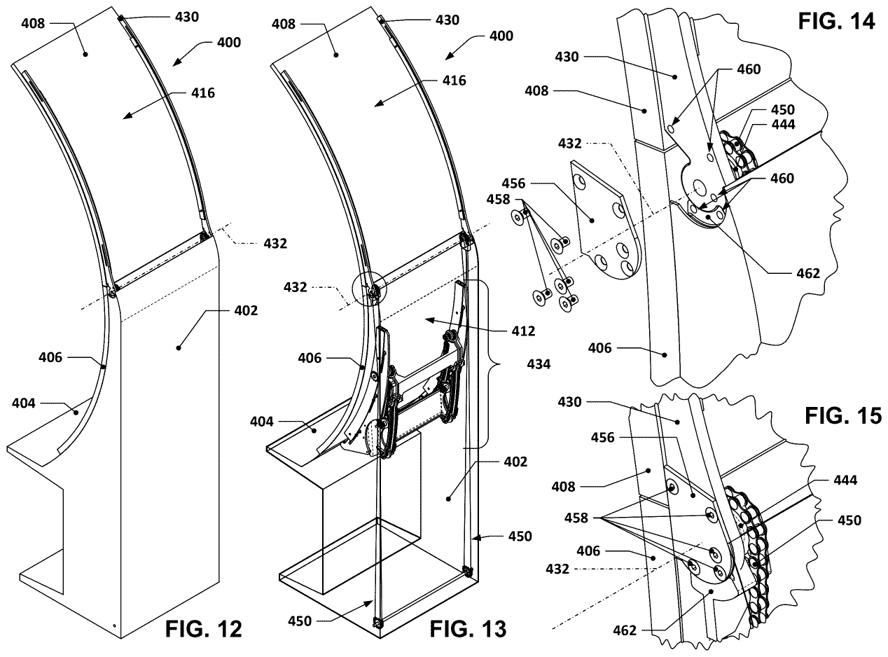

The movement of the one or more support arms 430 may be driven by a drive mechanism that is internal to the electronic gaming machine 400. FIG. 12 is an isometric rear view of the dual-display electronic gaming machine of FIG. 4; FIG. 13 is the same view of the dual-display electronic gaming machine of FIG. 12 but with the cabinet shown as transparent. FIG. 14 is an exploded view of a hinge assembly and locking plate for the dual-display electronic gaming machine of FIG. 13, e.g., within the circled area in FIG. 13. FIG. 15 is a view of the locking plate installed in the hinge assembly of the dual-display electronic gaming machine of FIG. 13. FIG. 16 is an exploded view of the dual-display electronic gaming machine of FIG. 4.

The drive mechanism may be seen in FIGS. 13 through 16. As can be seen, the drive mechanism may include, for example, drive sprockets 446 and driven sprockets 444. The drive sprockets 446 may, for example, be configured to rotate about a second axis 433 that may be located near the base 401 of the gaming machine cabinet 402. For example, the drive sprockets 446 may be connected with a shaft that may be configured to rotate about the second axis 433 responsive to a rotational input, e.g., provided by a cordless drill that may be coupled to the shaft, either directly or via an intermediate gear train (not shown). The rotational input may, for example, be accessible from outside of the cabinet 402.

The driven sprockets 444 may, for example, be fixedly connected with the one or more support arms 430 and may be configured to rotate about the first axis 432 such that when the driven sprockets 444 are caused to rotate about the first axis 432, the one or more support arms 430 rotate in unison with the driven sprockets 444.

The driven sprockets 444 may be kinematically coupled with the drive sprockets 446 by way of chains 450. Only portions of the chains 450 are shown, but the chains 450 will be understood to extend along the paths shown as linking the various ends of the chains 450 that are shown. In some instances, one or more idler sprockets 448 or similar idler devices may be provided in order to guide the chains 450 within the cabinet 402. Such idler sprockets 448 may, for example, be used to push the chains 450 away from the region where the main display panel 406 is located, thereby allowing the chains 450 to occupy an area that is narrower in width than the width of the driven sprockets 444 and allowing the cabinet 404 to potentially be shallowed in depth. In other implementations, idler sprockets 448 may be omitted. In some implementations, the chains 450 may not form a full loop around the driven sprockets 444 and the drive sprockets 446. For example, only a single length of chain may span between each driven sprocket 444 and corresponding drive sprocket 446. In such an implementation, the position of the secondary display panel 408 may be stably maintained through a combination of tension provided by the single length of chain for each driven sprocket 444 and the force of gravity on the secondary display panel 408.

It will be understood that other drive mechanisms may also be used in place of the chain drive shown. For example, a system of belt or strap drives may be used to impart rotational motion to the support arms 430; such implementations may replace the sprockets with rollers or similar equipment. In other implementations, the rotational movement of the support arms 430 may be driven by a gear train, e.g., worm or bevel gears that may be configured to mesh with matching gears used in place of the driven sprockets 446.

Once the secondary display panel 408 is in its fully upright position, locking plates 456 may be fastened to portions of the one or more support arms 430 and to portions of the electronic gaming machine 400 that remain fixed in place relative to the cabinet 402. For example, each support arm 430 may be rotatably connected with a bracket 462 in order form a hinge assembly. The brackets 462 may be connected with the cabinet 402 such that the brackets are fixed in space relative to the cabinet 402. The brackets 462 and the support arm(s) 430 may, for example, each have threaded holes in several locations in the proximity of the first axis 432. Each locking plate 456 may, for example, have a hole pattern that matches the relative positions of the threaded holes for the bracket 462 and the support arm 430 that form one of the hinge assemblies when the support arm 430 is in the fully upright position. Screws 458 may then be inserted through such holes and screwed into the threaded holes in the support arm 430 and the bracket 462 and tightened, thereby fixing the support arm 430 in place relative to the cabinet 402 (see FIG. 15) and ensuring that the secondary display panel will be firmly fixed in place (thereby avoiding any potential movements that may occur due to slop or tolerance mismatch in the drive mechanism) and preventing the secondary display panel 408 from accidentally falling back into the stowed position if there is a failure, for example, in a chain link in the chain 450. The locking plates 456 are shown as being visible on the exterior of the electronic gaming machine, but it will be understood that the locking plates 456 may also be positioned within the interior of the cabinet 402 in some implementations.

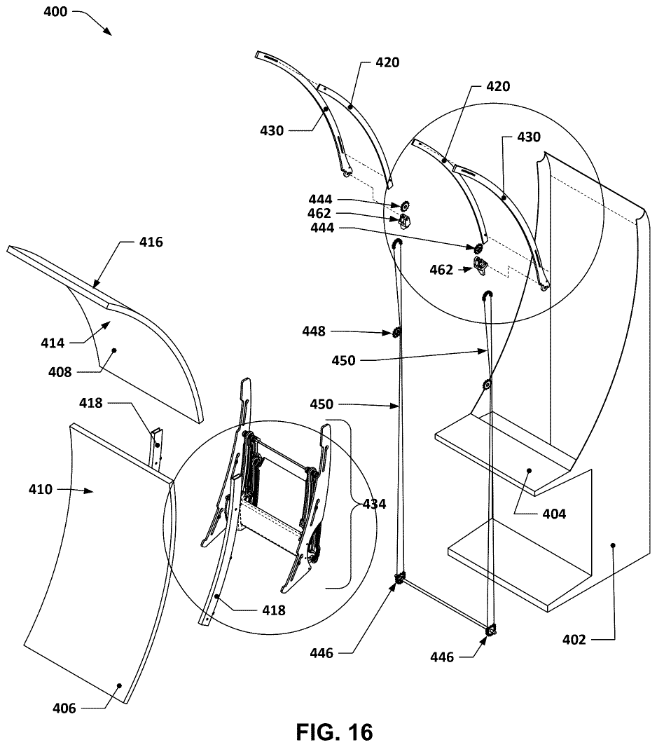

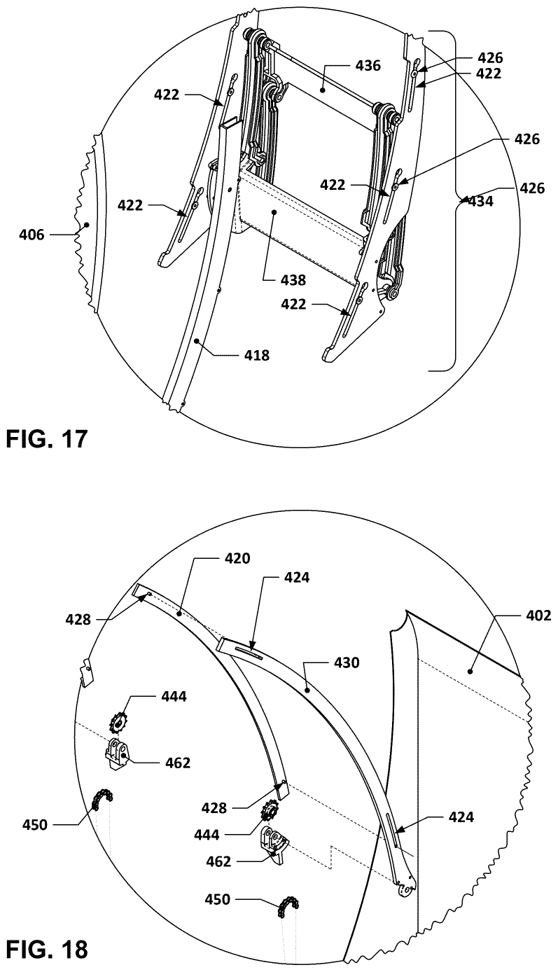

FIGS. 17 and 18 depict detail views of the portions of FIG. 16 that are circled in FIG. 16. As can be seen in FIG. 17, the main display panel 406 may be connected with main display brackets 418, e.g., the main display brackets 418 may be connected to the main display panel 406 using screws or other fasteners that serve to fix the main display panel 406 in place relative to the main display bracket 418. The main display brackets 418 may, in turn, be movably connected with a display mount 434 such that the main display brackets 418, and the main display panel 406 connected thereto, may move along a path relative to the display mount 434. In this example, such movement is provided by way of first slots 422 in the display mount 434 and first rollers 426 that are rotatably connected with the main display brackets 418 and that are captured within the first slots 422. In FIGS. 16 and 17, the first rollers 426 are shown removed from the main display brackets 418 and are located in their “captured” positions within the first slots 422. The holes visible in the main display brackets 418 align with where the axles for the first rollers 426 would interface with the main display brackets 418 when installed.

The first slots 422 in this example follow concentric arcuate paths, thereby constraining the main display brackets 418 and the main display panel 406 to movement along an arcuate path. Such an arcuate path may be used with main display panels 406 that are, like the depicted example, arcuate in nature. The arcuate path, in this case, has a center point that aligns with a center axis of an arcuate surface of the main display panel 406, thereby allowing the main display panel 406 to, in effect, move or slide in an arcuate manner such that the path of motion of the main display panel is the same as or similar to an arcuate profile of the main display panel 406, e.g., the profile of the main display panel back side 412. In implementations in which the main display panel 406 has a different form factor, e.g., a flat form factor, then the first slots 422 may instead be linear slots and the path followed by the main display panel 406 may be a linear path instead of an arcuate path. Other implementations may have differently configured first slots 422. For example, in some instances, the first slots 422 may follow a non-linear or non-arcuate path, or a path that is mostly linear or arcuate except at certain locations. For example, in some instances, such a path may first act to move the main display panel 406 outward from the cabinet 402 before causing the main display panel to move along a path that is parallel to the edge of the cabinet 402 and then move back towards the cabinet 402, thereby providing a gap between the main display panel 406 and the cabinet 402 during most of the movement of the main display panel 406; such an approach may avoid potential rubbing between the main display panel 406 and the cabinet 402 during such movement.

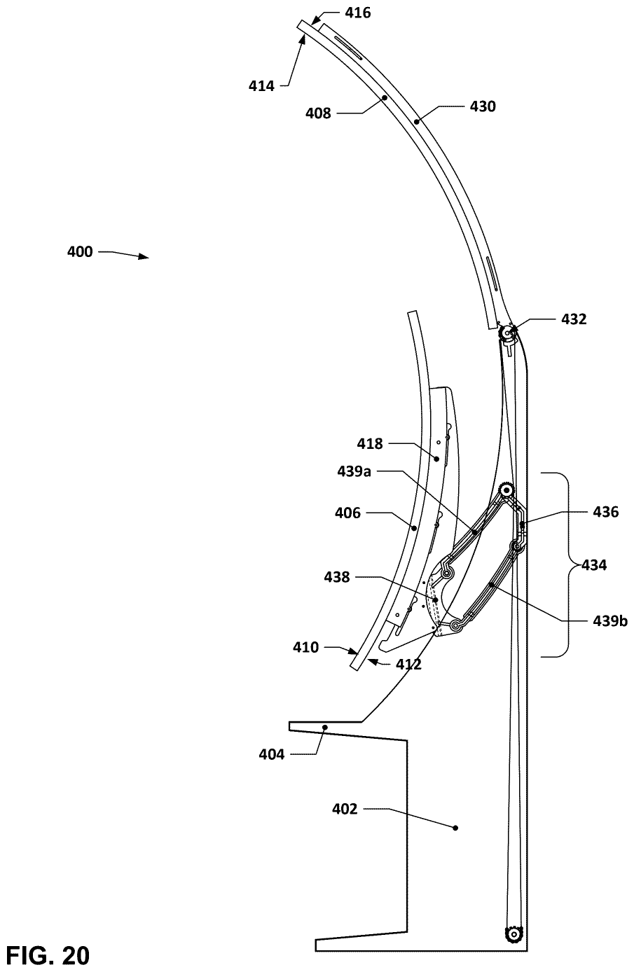

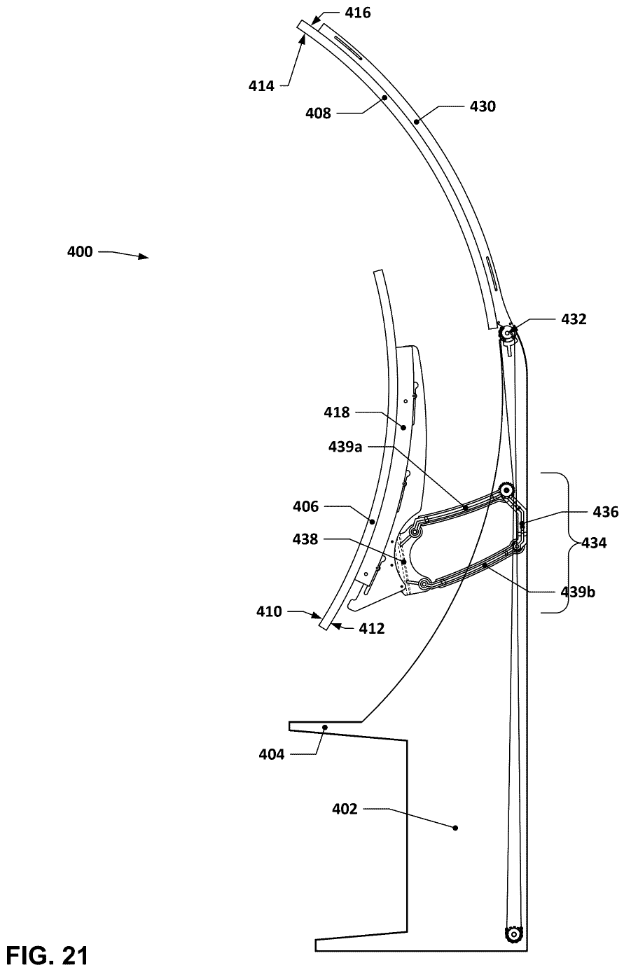

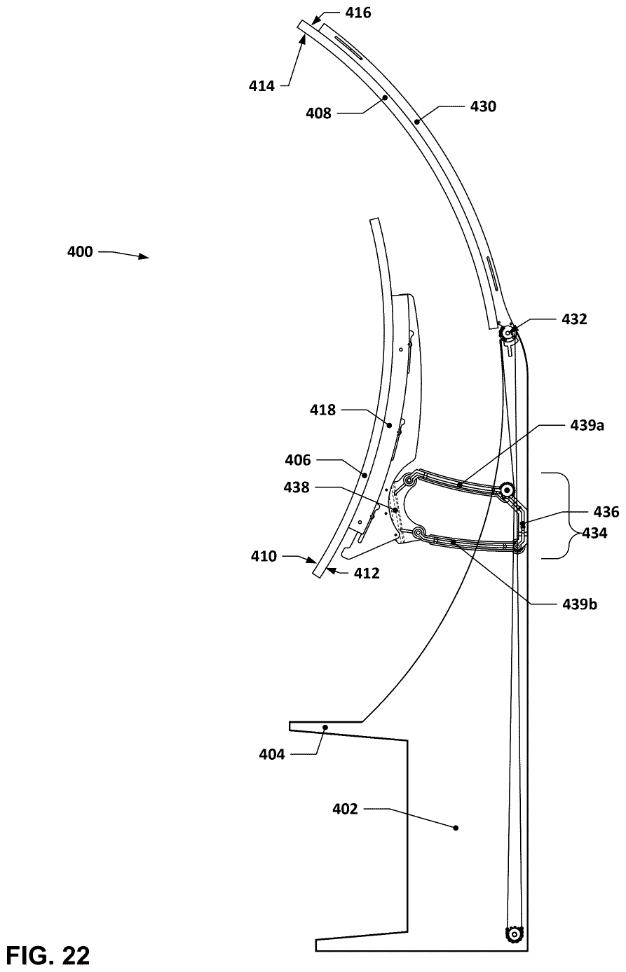

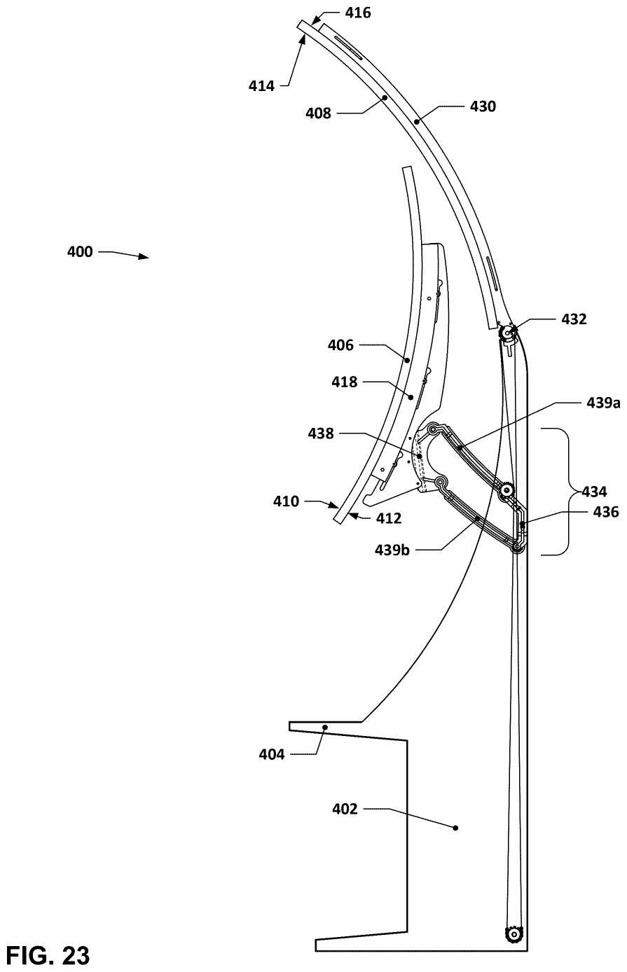

The depicted display mount 434 in this example is an articulated display mount 434 that has a base portion 436 and a movable portion 438. The first slots 422 are, in this example, located in the movable portion 438. The base portion 436, in contrast, is mounted in a fixed manner relative to the cabinet 402. The display mount 434 in this example includes two four-bar linkages (two of the links in each four-bar linkage are provided by the movable portion(s) and the base portion) that allow the movable portion 438 to be pulled out and upward from the cabinet 402 to allow the main display panel 406 to be positioned outward from the cabinet 402 in order to allow technician access to the internal systems of the electronic gaming machine that are located behind and underneath the main display panel 406. Such movements are discussed later with respect to FIGS. 20 through 23.

As can be seen in FIG. 18, the support arms 430 in this example include second slots 424 that receive second rollers 428 that are attached to the secondary display brackets 420. The second slots 424, similar to the first slots 422, follow concentric arcuate paths in this example and thereby constrain the second rollers 428 to follow such arcuate paths when the secondary display brackets 420, and the secondary display panel 408 attached thereto, are caused to move relative to the support arms 430. Such movement may, for example, be similar to that discussed above with respect to the main display panel 406.

It will be understood that the locations of the first slots 422 and/or the second slots 424 may be reversed from the positions shown. For example, the first slots 422 may be located in the main display bracket 418 and the first rollers 426 may be located in the display mount 434. The locations of the second slots 424 and the second rollers 428 may similarly be switched, if desired. It will also be understood that other mechanisms for facilitating relative movement between the main display panel 406 and the display mount 434 and/or the secondary display panel 408 and the support arm(s) 430 may also be used, e.g., rails and rollers, slides, etc.; the concepts discussed herein may be implemented with any suitable mechanism for providing such movements.

It will also be understood that the electronic gaming machine 400 may include features such as dampers, air pistons, etc., that may be arranged so as to damp or slow movement of the main display panel 406 and/or the secondary display panel 408 relative to the portions of the electronic gaming machine 400 to which they are attached. For example, an air piston or damper may be connected between the secondary display panel 408 and the support arms 430 such that when the secondary display panel 408 moves from the stowed position to the deployed position, the air piston or damper is compressed and resists or slows such movement, thereby avoiding sudden impacts that may arise if the secondary display panel 408 is allowed to slide freely relative to the support arms 430. The electronic gaming machine 400 may also include features such as set screws, latches, locks, etc. that may be able to be engaged in order to limit or prevent movement of the main display panel 406 or the secondary display panel 408 relative to the cabinet 402. Once the electronic gaming machine 400 is fully deployed, such additional securement features may be engaged in order to complete the initial setup process of the electronic gaming machine 400.

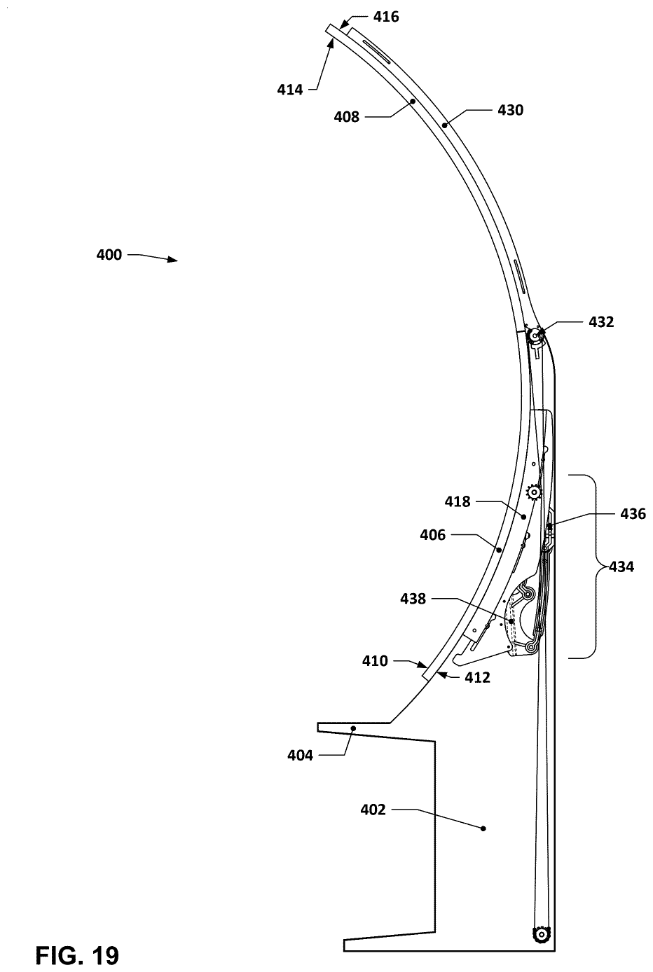

As discussed earlier, some implementations may feature a display mount 434 that is able to be reconfigured so as to allow a movable portion 438 thereof to move upward and outward from a base portion 436 thereof. FIGS. 19 through 23 depict such a mechanism in operation.

As can be seen in FIGS. 19 through 23, the base portion 436 of the display mount 434 may be mounted to the cabinet 402 and remain stationary. The main display brackets 418 may be mounted to the movable portion 438 of the display mount 434. The movable portion 438 and the base portion 436 of the movable display mount may be rotationally coupled with upper links 439a and lower links 439b, which may, in concert with the movable portion 438 and the base portion 436, form a four-bar linkage that allows the main display panel to be pulled outward and then transitioned to moving upward. The display mount 434 may, in some instances, include gas springs or other mechanisms (not shown) that may compensate for the weight of the main display panel 406 such that when the main display panel 406 is lifted upwards, such devices counteract the force of gravity and maintain the main display panel 406 in such an elevated position.

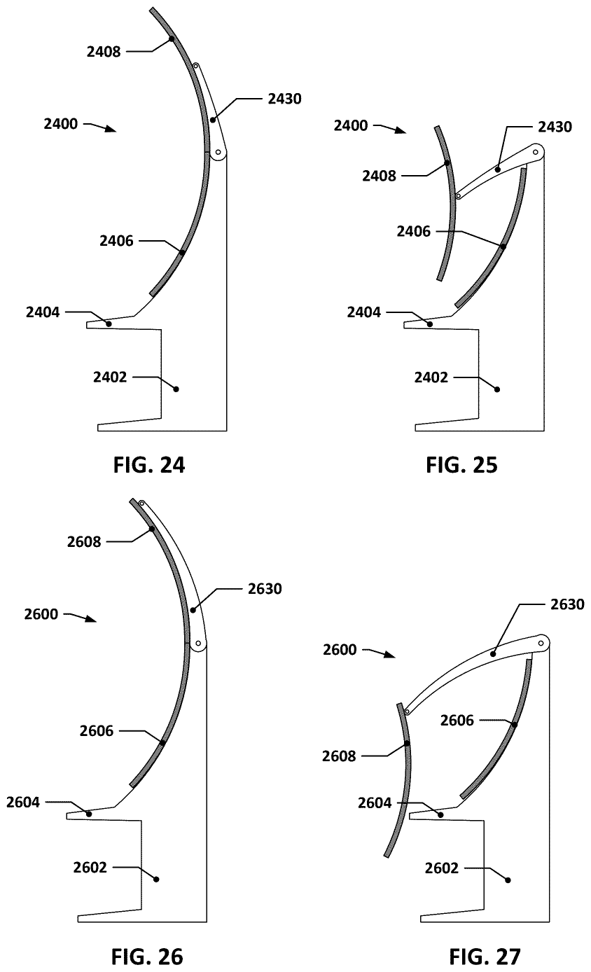

It will be noted that variants of the above-disclosed concepts are also within the scope of this disclosure. For example, in some implementations, the secondary display panel may be rotatably coupled with the support arm(s) instead of being able to move along a path relative to the support arm(s). FIGS. 24 through 27 depict two different examples of such implementations in simplified schematic form. It will be understood that elements of FIGS. 24 through 27 not explicitly described above but having callouts where the last two digits are shared with the last two digits of elements discussed earlier herein may generally be assumed to be similar to such earlier-discussed elements, and that the discussion of such earlier elements is also applicable to the versions of such elements depicted in FIGS. 24 through 27 unless otherwise indicated or apparent.

FIGS. 24 and 25 depict an example electronic gaming machine in which the support arm 2430 has a first end that is rotatably connected with the cabinet 2402 and configured to rotate about a first axis relative to the cabinet 2402; the first axis may pass through the first end of the support arm 2430. FIG. 24 shows the example electronic gaming machine in the deployed configuration, while FIG. 25 shows the electronic gaming machine in the stowed configuration. The support arm 2430 also has a second end that is rotatably connected with the secondary display panel 2408. For example, there may be a hinge mount on the back side of the secondary display panel 2408 that may connect with the second end(s) of the support arm(s) 2430 in a manner that allows the secondary display panel 2408 to rotate about a second axis relative to the support arm(s) 2430. In the implementation shown in FIGS. 24 and 25, the secondary display panel 2408 remains at an elevation higher than the button deck regardless of whether it is in the deployed configuration or the stowed configuration. However, the secondary display surface of the secondary display panel may face away from the main display surface of the main display panel 2406, in contrast to the implementation discussed above with respect to the earlier Figures.

FIGS. 26 and 27 depict a similar implementation to that shown in FIGS. 24 and 25, except that the second axis about which the secondary display panel 2608 can rotate relative to the support arm(s) 2630 is located near the upper edge of the secondary display panel 2608, e.g., within the top 20% of the secondary display panel 2608. In contrast, the second axis for the secondary display panel 2408 is located near the middle of the secondary display panel 2408, e.g., within the middle 30% of the secondary display panel 2408. Such an arrangement allows the secondary display panel, when in the stowed configuration, to be be positioned with at least a portion thereof being at a lower elevation than the button deck 2604 and with the button deck 2604 being positioned between the cabinet 2602 and the secondary display panel 2408.

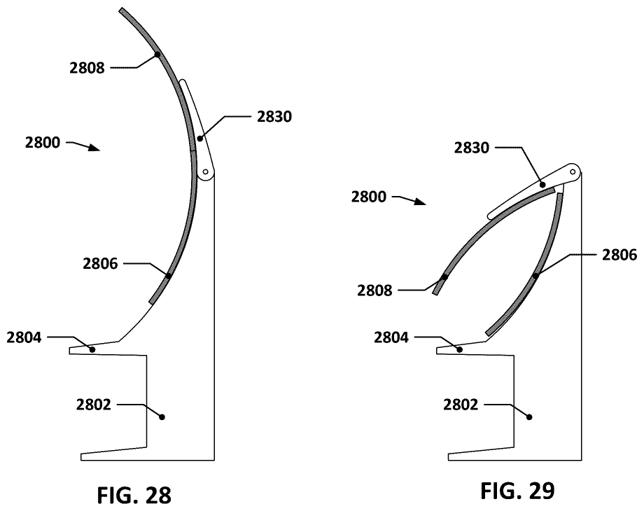

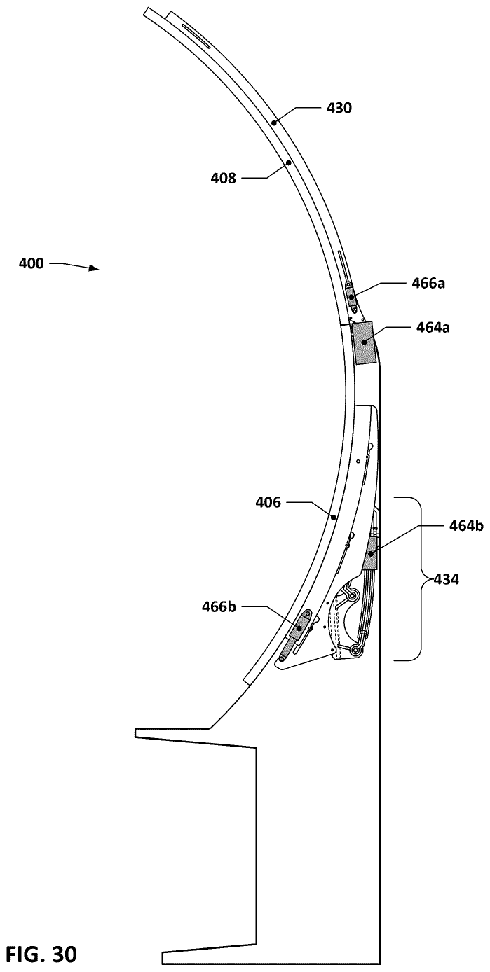

FIGS. 28 and 29 depict another example implementation of the concepts discussed herein. In this example, the electronic gaming machine is configured to transition between stowed and deployed configurations in much the same manner as the example electronic gaming machine 400. However, in this implementation, the secondary display panel 2808 is fixedly mounted with respect to the support arms 2830, i.e., the secondary display panel 2808 is fixed in space relative to the support arms 2830. In contrast, the secondary display panel 408 was mounted so as to be able to move along the curvature of the support arm(s) 430 by a small amount in order to allow it to exit the first region 442 in preparation for transitioning to the stowed configuration. In the example of FIGS. 28 and 29, the secondary display panel 2808 is, in effect, permanently mounted in the position that the secondary display panel 408 is in relative to the support arms 430 when in the stowed configuration. To compensate for this, the main display panel 2806 in this example is provided with a greater range of motion along the path that allows it to slide up into the first region to a greater extent than the main display panel 406. It will be understood that in a variant of such an implementation, the movement characteristics of the main display panel 2806 and the secondary display panel 2808 may be reversed, e.g., the main display panel 2806 may be unable to move upwards along the path and into the first region, but the secondary display panel 2808 may be provided with a greater range of motion along such a path in order to allow it to enter the first region and butt up against the top edge of the main display panel 2806.

It will be understood that elements of FIGS. 24 through 29 not explicitly described above but having callouts where the last two digits are shared with the last two digits of elements discussed earlier herein may generally be assumed to be similar to such earlier-discussed elements, and that the discussion of such earlier elements is also applicable to the versions of such elements depicted in FIGS. 24 through 29, unless otherwise indicated or apparent.

It will be understood that the various movable elements in the example electronic gaming machines discussed above may be either manually movable, e.g., able to be moved through the effort of one or two people using their bare hands, or configured to be moved by a powered input, e.g., such as an externally provided drill or other rotary input device or by motors or actuators located within the electronic gaming machine. FIG. 30 depicts a side view of an example of an electronic gaming machine such as that shown in FIG. 4, but with various drive systems depicted. For example, the rotational motion of the support arms 430 about the first axis may, in some instances, be caused by a direct-drive motor 464a (or pair of motors) that are configured to have a rotational output that has a rotational axis aligned with the first axis and that is coupled to the support arms 430. In some alternative such implementations, the electronic gaming machine may include a chain drive or other drive mechanism that allows a rotational input provided elsewhere than at the first axis to actuate the support arms 430. In such implementations, the motor 464a may be positioned adjacent, for example, the drive sprockets 446 discussed earlier and the rotational output of the motor 464a may be kinematically coupled with the drive sprockets 446 such that when the motor is actuated to drive the rotational output thereof, the drive sprockets 446 are caused to rotate about their respective axes, thereby driving the rotational movement of the driven sprockets 448 and the support arms 430.

Also visible in FIG. 30 are linear actuators 466a and 466b. The linear actuator 466a may be configured to drive movement of the secondary display panel 408 relative to the support arms 430, while the linear actuator 466b may be configured to drive movement of the main display panel 460 relative to the display mount 434. Finally a motor 464b that is configured to provide rotational input to the lower links 439b relative to the base portion 438, thereby causing the lower links 439b to rotate and cause the main display panel 406 to swing up and out from the cabinet for maintenance access.

It will be understood that the motors 464 and the actuators 466 may be replaced by any suitable mechanism, e.g., electric motors, linear actuators, pneumatic actuators, hydraulic actuators, etc., and may be selectively installed. For example, the motor 464 may be installed and used to drive movement of the support arms 430, but the other drive systems may be omitted. Other configurations are possible as well, depending on the degree of automation that is desired. In some such instances, the drive systems may be computer-controlled, such that the motors and/or actuators undergo one or more actions or behaviors that cause the electronic gaming machine 400 to undergo one or more movements as described herein.

It is to be understood that the phrases “for each <item> of the one or more <items>,” “each <item> of the one or more <items>,” or the like, if used herein, are inclusive of both a single-item group and multiple-item groups, i.e., the phrase “for . . . each” is used in the sense that it is used in programming languages to refer to each item of whatever population of items is referenced. For example, if the population of items referenced is a single item, then “each” would refer to only that single item (despite the fact that dictionary definitions of “each” frequently define the term to refer to “every one of two or more things”) and would not imply that there must be at least two of those items. Similarly, the term “set” or “subset” should not be viewed, in itself, as necessarily encompassing a plurality of items—it will be understood that a set or a subset can encompass only one member or multiple members (unless the context indicates otherwise).

The use, if any, of ordinal indicators, e.g., (a), (b), (c) . . . or the like, in this disclosure and claims is to be understood as not conveying any particular order or sequence, except to the extent that such an order or sequence is explicitly indicated. For example, if there are three steps labeled (i), (ii), and (iii), it is to be understood that these steps may be performed in any order (or even concurrently, if not otherwise contraindicated) unless indicated otherwise. For example, if step (ii) involves the handling of an element that is created in step (i), then step (ii) may be viewed as happening at some point after step (i). Similarly, if step (i) involves the handling of an element that is created in step (ii), the reverse is to be understood. It is also to be understood that use of the ordinal indicator “first” herein, e.g., “a first item,” should not be read as suggesting, implicitly or inherently, that there is necessarily a “second” instance, e.g., “a second item.”

It should be appreciated that all combinations of the foregoing concepts (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

It is to be further understood that the above disclosure, while focusing on a particular example implementation or implementations, is not limited to only the discussed example, but may also apply to similar variants and mechanisms as well, and such similar variants and mechanisms are also considered to be within the scope of this disclosure.

What is claimed is:

1. An apparatus comprising:
a cabinet;
a main display panel having a main display surface configured to display graphical output and a main display back side facing in an opposite direction from the main display surface;
a secondary display panel having a secondary display surface configured to display graphical output and a secondary display back side facing in an opposite direction from the main display surface;
one or more support arms connected with the secondary display panel, the one or more support arms configured to rotate about a first axis relative to the cabinet and between a stowed position and a deployed position; and
a display mount with a base portion and a movable portion, wherein the base portion is connected with the cabinet, the main display panel is connected with the movable portion, and the movable portion is configured to move along a first path relative to the base portion, wherein:
the main display surface of the main display panel faces towards the secondary display panel when the one or more support arms are in the stowed position, and
the main display surface of the main display panel and the secondary display surface of the secondary display panel both face in a common direction when the one or more support arms are in the deployed position.

2. The apparatus of claim 1, wherein:
the movable portion of the display mount is movable between a first position and a second position relative to the base portion,
a portion of the secondary display panel occupies a first region when the one or more support arms are in the stowed position and the movable portion of the display mount is in the first position, and
a portion of the main display panel occupies the first region when the one or more support arms are in the deployed position and the movable portion of the display mount is in the second position.

3. The apparatus of claim 2, wherein:
no portion of the main display panel occupies the first region when the one or more support arms are in the stowed position and the movable portion of the display mount is in the first position, and
no portion of the secondary display panel occupies the first region when the one or more support arms are in the deployed position and the movable portion of the display mount is in the second position.

4. The apparatus of claim 1, further comprising a button deck, wherein the button deck is connected with the cabinet and the main display panel and the secondary display panel are positioned at a higher elevation than the button deck regardless of whether the one or more support arms are in the stowed position or the deployed position and regardless of whether the movable portion of the display mount is in the first position or the second position.

5. The apparatus of claim 1, further comprising:
a driven sprocket;
a drive sprocket; and
a chain, wherein:
the driven sprocket is configured to rotate about the first axis and is fixedly connected with the one or more support arms,
the drive sprocket is located within the cabinet and at a lower elevation than the drive sprocket, and
the chain is engaged with the driven sprocket and with the drive sprocket.

6. The apparatus of claim 5, wherein the drive sprocket is located in a base of the cabinet and at an elevation lower than any part of the main display panel.

7. The apparatus of claim 6, further comprising a drive mechanism with a rotational input and a rotational output, wherein:
the rotational output is coupled with the drive sprocket and configured to cause the drive sprocket, and thus the one or more support arms, to rotate about the first axis responsive to rotation of the rotational output, and
the rotational input is accessible from outside of the cabinet.

8. The apparatus of claim 1, wherein, when the one or more support arms are in the deployed position and the movable portion of the display mount is in the second position:
a top edge of the main display panel and a bottom edge of the secondary display panel are adjacent to one another, and
the main display surface of the main display panel adjacent the top edge of the main display panel is tangent to, and aligned with, the secondary display surface of the secondary display panel adjacent the bottom edge of the secondary display panel.

9. The apparatus of claim 1, wherein the main display panel has a curved profile when viewed along the first axis.

10. The apparatus of claim 9, wherein the secondary display panel has a curved profile when viewed along the first axis.

11. The apparatus of claim 1, wherein the secondary display panel has a curved profile when viewed along the first axis.

12. The apparatus of claim 1, wherein the main display surface of the main display panel faces towards the secondary display surface of the secondary display panel when the one or more support arms are in the stowed position.

13. The apparatus of claim 12, wherein the secondary display panel is fixedly mounted with respect to the one or more support arms.

14. The apparatus of claim 12, wherein the secondary display panel is movably coupled with the one or more support arms and is configured to move along a path relative to the one or more support arms.

15. The apparatus of claim 1, wherein the secondary display surface of the secondary display panel faces away from the main display surface of the main display panel when the one or more support arms are in the stowed position.

16. The apparatus of claim 15, wherein:
each support arm of the one or more support arms has a first end and a second end opposite the first end,
the first axis passes through the first end or first ends of the one or more support arms,
the secondary display panel is rotatably connected with the second end or second ends of the one or more support arms,
the secondary display panel is configured to rotate about a second axis relative to the one or more support arms, and
the second axis passes through the second end or second ends of the one or more support arms.

17. The apparatus of claim 16, further comprising a button deck, wherein the button deck is connected with the cabinet and the main display panel and the secondary display panel are positioned at a higher elevation than the button deck regardless of whether the one or more support arms are in the stowed position or the deployed position and regardless of whether the movable portion of the display mount is in the first position or the second position.

18. The apparatus of claim 16, further comprising a button deck, wherein:
the button deck is connected with the cabinet,
the main display panel and the secondary display panel are positioned at a higher elevation than the button deck when the one or more support arms are in the deployed position and the movable portion of the display mount is in the second position,
the main display surface of the main display panel faces towards the secondary display back side of the secondary display panel when the one or more support arms are in the stowed position and the movable portion of the display mount is in the first position, and
the button deck is between the cabinet and the secondary display panel when the one or more support arms are in the stowed position and the movable portion of the display mount is in the first position.

19. The apparatus of claim 1, further comprising one or more locking plates, each locking plate connected with one of the one or more support arms and with the cabinet or a structure that is fixed in space relative to the cabinet.

20. The apparatus of claim 1, further comprising a motor configured to, when actuated, cause the one or more support arms to rotate about the first axis relative to the cabinet.
